(19) United States
(12) Patent Application Publication
(10) Pub. No.: US 2009/0311620 A1
(43) Pub. Date: Dec. 17, 2009

(54) CARRIER, TWO-COMPONENT DEVELOPER COMPRISING THE SAME, AND DEVELOPING DEVICE AND IMAGE FORMING APPARATUS USING THE TWO-COMPONENT DEVELOPER

(76) Inventors: Kanako Hirata, Osaka (JP); Kazuki Takatsuka, Osaka (JP); Toru Nishikawa, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/482,663

(22) Filed: Jun. 11, 2009

(30) Foreign Application Priority Data
Jun. 13, 2008 (JP) P2008-155976

(51) Int. Cl. G03G 9/00

(52) U.S. Cl. 430/111.1

(57) ABSTRACT

A carrier has a thermosetting silicone resin layer formed of a core particle and a thermosetting silicone resin on the surface of the core particle, and the thermosetting silicone resin layer is formed by subjecting a thermosetting silicone resin to a thermosetting treatment at a temperature lower than the melting point of a charge control agent contained in the thermosetting silicone resin layer, and includes an inner region which contains a positively chargeable charge control agent and an outer region which does not contain any positively chargeable charge control agent. The two-component developer containing the carrier as described above is charged into a developing device in an image forming apparatus to form an image.

### CROSS-REFERENCE TO RELATED APPLICATION

This application claims priority to Japanese Patent Application No. 2008-155976, which was filed on Jun. 13, 2008, the contents of which are incorporated herein by reference in their entirety.

### BACKGROUND OF THE INVENTION

1. Field of the Invention

The present invention relates to a carrier, a two-component developer comprising the same, and a developing device and an image forming apparatus which employ the two-component developer.

2. Description of the Related Art

An image forming apparatus employing an electrophotographic system performs, for example, a charging step, an exposure step, a developing step, a transfer step, a cleaning step, a charge removing step, and a fixing step to form an image. In the step for forming an image, for example, a surface of a photoreceptor driven for rotation by a charging device is uniformly charged, and a laser beam is irradiated onto the surface of the photoreceptor charged by an exposure device to form an electrostatic latent image. Subsequently, the electrostatic latent image on the photoreceptor is developed by a developing device to form a toner image on the surface of the photoreceptor. The toner image on the photoreceptor is transferred to a transfer material by a transfer device, and then the toner image is fixed on the transfer material by heating by means of a fixing device. Further, the transfer toner remaining on the surface of the photoreceptor is removed by a cleaning device, and collected into a predetermined collection part. Further, the remaining charges are removed from the surface of the photoreceptor after being cleaned by a charge removing device for the preparation of next image formation.

As developer for developing the electrostatic latent image formed on the surface of the photoreceptor, for example, a one-component developer formed of a toner only, and a two-component developer formed of a toner and a carrier have been used.

The one-component developer is advantageous in that the developing section has a simple structure with no need of an agitating mechanism, etc. for mixing the toner and the carrier evenly since the one-component developer contains no carrier. However, the one-component developer has disadvantages such that stabilization of a charge amount of the toner is not easy.

The two-component developer has a disadvantage that an agitation mechanism and the like to evenly mix a toner and a carrier are required, which makes the developing device more complicate. However, it is excellent in charging stability or suitability to a high-speed machine. Therefore, it is often used in a high-speed image forming apparatus or a color image forming apparatus.

As a carrier used in the two-component developer, for example, a magnetic particle comprising a ferrite having a particle size of 20 to 100 μm, or the like is used. For this magnetic particle, for example, a magnetic particle is used as a core particle to form a resin layer comprising an acrylic resin or a silicone-based resin on the surface in order to prevent humidity dependency or cohesiveness of the toner components. Particularly, the carrier coated on the surface of the core particle in the thermosetting silicone resin makes the adhesion of the toner components or the like harder, and also has excellent durability.

As the carrier having the resin layer as described above, for example, an electrophotographic carrier having a resin coated in the shape of a powder particle, in which the resin is a mixture of a thermosetting silicone resin and a thermoplastic silicone resin, is disclosed in Japanese Unexamined Patent Publication JP-A 9-6054 (1997). However, in the case of using a two-component developer comprising the carrier as disclosed in JP-A 9-6054 having the surface coated with a thermosetting silicone resin to form an image, the resin layer starts to wear out from the 30000th sheet due to the agitation in the image forming apparatus, the charge amount lowers, and fogging occurs. Regarding these problems, a measure in which a charge control agent having a polarity opposite the polarity of a toner is added to a silicone resin, and the silicone resin is used in a resin layer to inhibit the reduction of the charge amount has been tried. However, since the variation in the charge amounts is generated due to the lot difference of the carrier, and accordingly, it was found that a constant image quality density cannot be maintained over a long period of time, even by taking such a measure.

Extensive studies have been made in order to solve the problem that the unevenness in the charge amounts occurs due to the lot difference of the carrier, and as a result, it was found that the unevenness in the charge amounts of a developer has a relationship with denaturation of a charge control agent by a thermosetting treatment for curing a silicone resin coated on the carrier surface. Although a concrete mechanism has not been clarified, it is presumed that under a heating condition for the thermosetting treatment of the silicone resin, the charge control agents are molten, which causes them to aggregate with each other or bleed on the carrier surface thereby changing the dispersion state, the dispersibility deteriorates, and accordingly the unevenness in the charge amounts occurs due to the lot difference of the carrier. Further, it is believed that a fact that a part of the charge control agents is thermally decomposed and is not crystallized upon cooling after the thermosetting treatment, but is rendered to be amorphous, and the like is also a cause of the unevenness in the charge amounts due to the lot difference of the carrier.

### SUMMARY OF THE INVENTION

It is an object of the invention to provide a carrier having good dispersibility of a charge control agent contained in a resin layer and having no lot difference, a two-component developer capable of inhibiting the unevenness in the charge amounts due to the lot difference by comprising the carrier, and a developing device and image forming apparatus, which is capable of stably forming an image having a constant image density over a long period of time by employing the two-component developer.

The invention provides a carrier comprising a core particle and a thermosetting silicone resin layer formed of a thermosetting silicone resin on a surface of the core particle,

the thermosetting silicone resin layer being formed by subjecting the thermosetting silicone resin to a thermosetting treatment at a temperature lower than a melting point of a charge control agent contained in the thermosetting silicone resin layer, the thermosetting silicone resin layer including an inner region which contains a positively chargeable charge control agent and an outer region which does not contain any positively chargeable charge control agent.

According to the invention, the carrier comprises a core particle and a thermosetting silicone resin layer formed of a thermosetting silicone resin on a surface of the core particle, and the thermosetting silicone resin layer is formed by subjecting a thermosetting silicone resin to a thermosetting treatment at a temperature lower than the melting point of a charge control agent contained in the thermosetting silicone resin layer, and contains a positively chargeable charge control agent. By forming the resin layer of the thermosetting silicone resin, the strength of the resin layer can be increased, as compared with a case of using an acrylic resin, and the like. By setting the thermosetting treatment temperature of the thermosetting silicone resin layer to be lower than the melting point of the charge control agent contained in the resin layer, the change in the dispersion states of the charge control agent is inhibited, which can lead to good dispersibility of the charge control agent. Further, the denaturation of the charge control agent can be inhibited. Accordingly, a carrier in which the change in the abilities of the carrier to impart charges to the toner is inhibited and the toner can be stably charged with a constant amount of charge can be implemented. By using such a carrier, an image having a constant image density can be stably formed without fogging, over a long period of time.

Furthermore, the thermosetting silicone resin layer includes an inner region contains a positively chargeable charge control agent and an outer region which does not contain any positively chargeable charge control agent. By not incorporating any positively chargeable charge control agent into the outer region of the thermosetting silicone resin layer, the strength of the thermosetting silicone resin layer can be increased, as compared with a case in which the outer region contains the charge control agent. Since the positively chargeable charge control agent is incorporated in the inner region of the thermosetting silicone resin layer, the decrease in the toner charge amount can be inhibited by the positively chargeable charge control agent that is present in the inner region of the thermosetting silicone resin layer even when the thermosetting silicone resin layer is worn, and the volume resistivity of the carrier is lowered. Accordingly, an image having a constant image density can be even more stably formed without fogging, over a long period of time.

Furthermore, in the invention, it is preferable that the thermosetting silicone resin layer contains, as a positively chargeable charge control agent, one or more of a quaternary ammonium salt represented by the following general formula (1), a quaternary ammonium salt represented by the following general formula (2), and a quaternary ammonium salt represented by the following general formula (3):

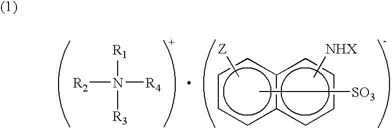

(wherein X represents an alkyl group, a cycloalkyl group, a substituted or unsubstituted phenyl group, or —COR₅ (R₅ is a lower alkyl group), and Z represents a hydrogen atom, a hydroxyl group, or an alkyl group. R₁ and R₃ each independently represent an alkyl group having 1 to 18 carbon atoms, or a benzyl group, R₂ represents an alkyl group having 1 to 4 carbon atoms, and R₄ represents an alkyl group having 5 to 18 carbon atoms, or a benzyl group.);

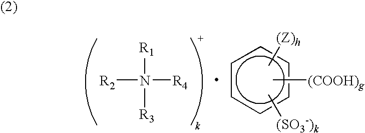

(wherein Z represents a hydrogen atom, a hydroxyl group, a substituted or unsubstituted alkyl group, an alkenyl group, or a carboxylic group, k represents an integer of 1 or 2, g and h each represent an integer of 1 to 3, and a sum of k, g, and h is 6 or less. R₁ to R₄ each independently represent a substituted or unsubstituted alkyl group having 1 to 18 carbon atoms, an alkenyl group having 1 to 18 carbon atoms, a cycloalkyl group, a substituted or unsubstituted phenyl group, or a substituted or unsubstituted benzyl group.); and

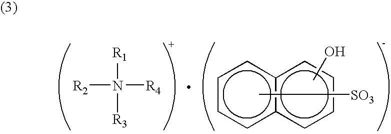

(wherein R₁ represents an alkyl group having 1 to 8 carbon atoms, R₂ and R₃ each independently represent an alkyl group having 1 to 18 carbon atoms, and R₄ represents an alkyl group having 1 to 8 carbon atoms, or a benzyl group.)

According to the invention, the thermosetting silicone resin layer contains, as a positively chargeable charge control agent, one or more of a quaternary ammonium salt represented by the general formula (1), a quaternary ammonium salt represented by the general formula (2), and a quaternary ammonium salt represented by the general formula (3). A quaternary ammonium salt substituted with an alkyl group or an aryl group exhibits an excellent dispersibility in a silicone resin dispersibility, and a high charge control effect. By incorporating one or more of the quaternary ammonium salts into the thermosetting silicone resin layer, the charge-imparting ability is stabilized even under a high humidity environment, and the toner charging can be started earlier, thereby preventing decrease in the toner charge amount. Further, since the quaternary ammonium salt is colorless, it is difficult to cause contamination with a color toner, and the color image can be prevented from being rendered turbid. Accordingly, an image having a constant image density can be more stably formed without causing fogging, over a long period of time.

Furthermore, in the invention, it is preferable that the thermosetting silicone resin layer contains the positively chargeable charge control agent in the inner region and contains a negatively chargeable charge control agent in the outer region.

According to the invention, the thermosetting silicone resin layer contains the positively chargeable charge control agent in the inner region and contains a negatively chargeable charge control agent in the outer region. By this, the decrease in the toner charge amount at a life can be inhibited, as well as the increase in the toner charge amount, immediately after a new two-component developer is set in an image forming apparatus, for example, during image forming starting at the initial period up through 2000 sheets, can be alleviated. Accordingly, since the unwanted increase in the toner charge amount can be prevented, immediately after a new two-component developer is set in an image forming apparatus, the decrease in the image densities to below a proper range is inhibited, and an image having a constant image density can be even more stably formed without fogging, over a long period of time.

Furthermore, in the invention, it is preferable that a ratio of a weight of the positively chargeable charge control agent to a weight of the negatively chargeable charge control agent is in a range of 2:1 to 1:2.

According to the invention, a ratio of a weight of the positively chargeable charge control agent to a weight of the negatively chargeable charge control agent is in the range of 2:1 to 1:2. The positively chargeable charge control agent is present in the inner region of the thermosetting silicone resin layer and the negatively chargeable charge control agent is present in the outer region, but both the charge control agents are present in the boundary between the place where the positively chargeable charge control agent is present and the place where the negatively chargeable charge control agent is present, and accordingly, the charge control effect is not sufficiently exhibited. Accordingly, in the case where the weight of the positively chargeable charge control agent is too smaller than that of the negatively chargeable charge control agent, the resin layer worn out, and the charge-imparting ability of the positively chargeable charge control agent is not sufficiently exhibited at a life when the volume resistivity of the carrier is lowered, and therefore, decrease in the charge amounts cannot be inhibited, whereby the fogging occurs. In the case where the weight of the positively chargeable charge control agent is too greater than that of the negatively chargeable charge control agent, the charge control effect of the negatively chargeable charge control agent is not sufficiently exhibited at the initial period of the image forming, and accordingly, the charge amount is unwantedly increased, whereby the image density was lowered. By setting the ratio of the weight of the positively chargeable charge control agent to the weight of the negatively chargeable charge control agent is in the range of 2:1 to 1:2, increase in the toner charge amount at the initial period is clearly alleviated, and decrease in the toner charge amount at a life can be clearly inhibited, and thus, an image having a constant image density can be even more stably formed without fogging, over a long period of time.

Furthermore, in the invention, it is preferable that the thermosetting silicone resin layer further contains a conductive agent in the outer region.

According to the invention, the thermosetting silicone resin layer further contains a conductive agent in the outer region. By further incorporating a conductive agent into the outer region of the resin layer, increase in the toner charge amount, immediately after a new two-component developer is set in an image forming apparatus, for example, during image forming starting at the initial period up through 2000 sheets, can be more clearly alleviated. Accordingly, since the unwanted increase in the toner charge amount immediately after a new two-component developer is set in an image forming apparatus, can be prevented, the decrease below a proper range of the image density can be inhibited, and an image having a constant image density can be even more stably formed without fogging, over a long period of time.

Furthermore, in the invention, it is preferable that the thermosetting silicone resin is a dimethyl silicone resin.

According to the invention, the thermosetting silicone resin is a dimethyl silicone resin. Since the dimethyl silicone resin has a dense crosslinked structure, in the case where a resin layer of a carrier is formed using the dimethyl silicone resin, it is difficult for the toner components such as a binder resin, and the like to be adhered onto the surface, and a carrier having good water repellency, moisture resistivity, and the like is obtained. Accordingly, an image having a constant image density can be even more stably formed without fogging, over a long period of time.

Furthermore, in the invention, it is preferable that the core particle contains a ferrite component.

According to the invention, the core particle comprises a ferrite component. By incorporating the ferrite component into the core particle, the density of the carrier can be lowered, and as a result, the torque of a conveying member, and the like in a developing device becomes light, and as compared with a carrier in which the core particle does not comprise a Ferrite component, a force applied to the carrier upon conveying to the conveying member can be lowered, and thus, it is possible to make it difficult for the resin layer to be worn. Furthermore, since the core particle containing a ferrite component has a high saturation magnetization, it has a strong adhesion force onto a developing roller, and it is difficult that the carrier adhesion onto an image bearing member occurs. By using the core particle comprising the ferrite component as described above, generation of white spots of the image due to adhesion of the carrier onto a photoreceptor can be prevented. Accordingly, the change in the toner charge amounts from an initial stage up through a life can be further regulated, and also, generation of white spots of the image can be prevented, and accordingly, an image having a constant image density can be even more stably formed.

Furthermore, the invention provides a two-component developer comprising a toner and the carrier mentioned above.

According to the invention, the two-component developer comprises a toner and the carrier mentioned above. The carrier mentioned above has good dispersibility of the charge control agent in the thermosetting silicone resin layer, as described above, and there is no denaturation of the charge control agent. By using such a carrier of the invention, and a toner as a two-component developer, the change in the abilities of the carrier to impart charges to a toner can be inhibited, and the toner can be stably charged with a constant amount of charge. Accordingly, a two-component developer which is capable of even more stably forming an image having a constant image density without fogging, over a long period of time can be made.

Furthermore, the invention provides a developing device which develops an electrostatic latent image formed on an image bearing member by using the two-component developer mentioned above to form a visible image.

According to the invention, the developing device develops the electrostatic latent image formed on the image bearing member using the two-component developer of the invention to form a visible image. For the two-component developer of the invention, the toner charge amount from an initial period through a life is stable, and thus, a developing device which can stably develop a good toner image without fogging, over a long period of time by using the two-component developer of the invention can be implemented.

Furthermore, the invention provides an image forming apparatus comprising:

an image bearing member on which an electrostatic latent image is formed;

a latent image forming section which forms the electrostatic latent image on the image bearing member; and

the developing device mentioned above.

According to the invention, an image forming apparatus which is equipped with the developing device mentioned above which is capable of implementing a toner image on an image bearing member without fogging as described above is implemented. By forming an image on the image forming apparatus as described above, an image having a constant image density can be stably formed without fogging.

### BRIEF DESCRIPTION OF THE DRAWINGS

Other and further objects, features, and advantages of the invention will be more explicit from the following detailed description taken with reference to the drawings wherein:

FIG. 1 is a cross-sectional view schematically showing the constitution of a carrier serving as a basis of a first embodiment of the invention;

FIG. 2 is a cross-sectional view schematically showing the constitution of a carrier according to one example of the first embodiment of the invention;

FIG. 3 is a cross-sectional view schematically showing the constitution of a carrier according to another example of the first embodiment of the invention;

FIG. 4 is a diagram schematically showing the construction of an image forming apparatus according to a third embodiment of the invention;

FIG. 5 is a diagram showing a first image forming unit as shown in FIG. 4; and

FIG. 6 is a diagram showing the construction of a periphery of a developing device in the first image forming unit as shown in FIG. 5.

### DETAILED DESCRIPTION

Now referring to the drawings, preferred embodiments of the invention are described below.

1. Carrier

A carrier according to a first embodiment of the invention comprises a core particle and a thermosetting silicone resin layer formed of a thermosetting silicone resin on the surface of the core particle, and the thermosetting silicone resin layer is formed by subjecting a thermosetting silicone resin to a thermosetting treatment at a temperature lower than the melting point of a charge control agent contained in the thermosetting silicone resin layer, and contains a positively chargeable charge control agent.

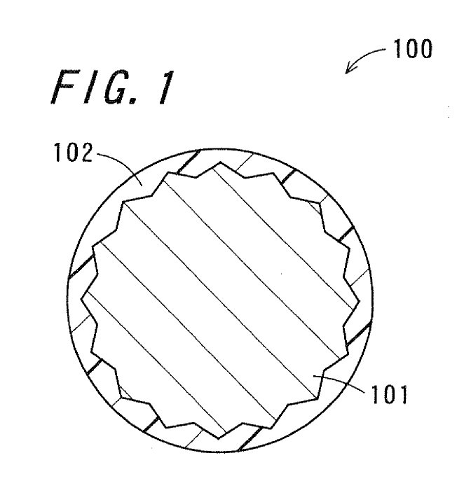

FIG. 1 is a cross-sectional view schematically showing the constitution of the carrier 100 serving as a basis of the first embodiment of the invention. The carrier 100 comprises a core particle 101 having unevenness, and a thermosetting silicone resin layer 102 formed of a thermosetting silicone resin on the surface of the core particle 101 having unevenness. The thermosetting silicone resin layer 102 contains a positively chargeable charge control agent.

(1) Core Particles

For the core particle 101, a known magnetic particle can be used, but a particle containing a ferrite component (ferrite-based particle) is preferable. By incorporating the ferrite component into the core particle 101, the density of the carrier can be lowered, and thus, the density of the carrier can be decreased, and as a result, the torque of a conveying member, and the like in a developing device becomes light, as compared with a carrier in which the core particle 101 does not contain a ferrite component, a force applied to the carrier upon conveying to the conveying member can be decreased, and thus, it is possible to make it difficult for the resin layer to worn out. Furthermore, since the core particle 101 containing a ferrite component has a high saturation magnetization, it has a strong adhesion force onto a developing roller, and it is difficult that the carrier adhesion onto an image bearing member occurs. By using the core particle 101 containing the ferrite component as described above, generation of white spots of the image can be prevented by adhesion of the carrier onto a photoreceptor. Accordingly, the change in the toner charge amounts from an initial period through a life can be further inhibited, and also, generation of white spots of the image can be prevented, and accordingly, an image having a constant image density can be even more stably formed.

(Ferrite Particles)

Usable examples of the ferrite particles include known substances such as zinc ferrite, nickel ferrite, copper ferrite, nickel-zinc ferrite, manganese-magnesium ferrite, copper-magnesium ferrite, manganese-zinc ferrite, and manganese-copper-zinc ferrite.

Ferrite particles can be manufactured by the known method. For example, ferrite raw materials such as Fe₂O₃ and Mg(OH)₂ are mixed and then, mixed powder thus obtained is heated in a heating furnace to be tentatively fired. The tentatively fired material thus obtained is cooled down and then pulverized by a vibrating mill into particles in the order of 1 μm. To pulverized powder thus obtained, a dispersant and water are added, resulting in a slurry. The slurry obtained is wet-pulverized by a wet ball mill, and suspension thus obtained is granulated and dried by a spray drier. The ferrite particles can be thus obtained.

(Physical Properties of Core Particle)

The volume average particle size of the core particles is preferably from 20 to 80 μm, and more preferably from 30 to 60 μm. The definition of the volume average particle size of the core particles will be described later.

The core particle preferably has a volume resistivity of 1×10⁶ to 1×10¹¹ Ω·cm as measured by a bridge method. A ferrite-based particle having a volume resistivity in this range is cheap, and thus, is generally in use. In the case where the volume resistivity of the core particle is lowered, fogging occurs on a toner image by poor electrical insulation in some cases. In the case where the volume resistivity of the core particle is enhanced, an edge effect or a lowered image density of the circumference of a solid image by the counter charge remaining on the carrier surface easily occurs. The volume resistivity of the core particle is preferably in the range of 1×10⁸ to 5×10¹⁰ Ω·cm. The definition of the volume resistivity will be described later.

(2) Thermosetting Silicone Resin Layer

The thermosetting silicone resin layer 102 formed of a thermosetting silicone resin on the surface of the core particle 101 is formed by subjecting the thermosetting silicone resin to a thermosetting treatment at a temperature lower than the melting point of a charge control agent contained in the thermosetting silicone resin layer 102, and contains a positively chargeable charge control agent. By forming the resin layer 102 of the thermosetting silicone resin, the strength of the resin layer 102 can be increased, as compared with a case of using an acrylic resin in the resin layer 102. In the case where a thermosetting treatment is performed at a temperature that is not lower than the melting point of the charge control agent contained in the resin layer 102, the charge control agent is easily modified, the lot difference of the carrier is generated, and accordingly, the charge-imparting ability of the carrier is not stable, and the toner charge amount is also not stable, but by performing the thermosetting treatment of the thermosetting silicone resin layer 102 at a temperature lower than the melting point of the charge control agent contained in the resin layer 102, the change in the dispersion states of the charge control agent is inhibited, which can lead to good dispersibility of the charge control agent. Further, the denaturation of the charge control agent can be inhibited. Accordingly, the change in the abilities of the carrier 100 to impart charges to the toner is inhibited, whereby the carrier 100 which allows the toner to be stably charged with a constant amount of charge can be attained. By using such a carrier 100, an image having a constant image density can be stably formed without fogging, over a long period of time.

(Thermosetting Silicone Resin)

The thermosetting silicone resin constituting the thermosetting silicone resin layer 102 is a silicone resin in which the hydroxyl groups bonding with a Si atom are cross-linked and cured by a thermal dehydration reaction, as shown below.

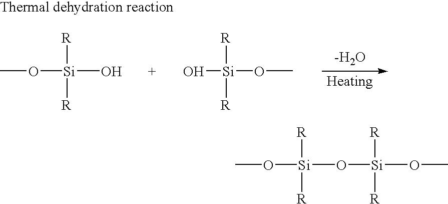

(wherein a plurality of R's represent the same or different monovalent organic group.)

Among the thermosetting silicone resins, a dimethyl silicone resin in which the monovalent organic group represented by R is a methyl group is preferable. Since the dimethyl silicone resin in which R is a methyl group has a dense crosslinked structure, in the case where the resin layer of a carrier is formed using the dimethyl silicone resin, it is difficult for the toner components such as a binder resin, and the like to be adhered onto the surface, and a carrier having good water repellency, moisture resistivity, and the like are obtained. Accordingly, an image having a constant image density can be even more stably formed without fogging, over a long period of time. However, since in the case where the crosslinked structure is too dense, the resin layer tends to be fragile, the selection of the molecular weight of the silicone resin is critical.

The weight ratio (Si/C) of silicon to carbon in the silicone resin is preferably 0.3 or more and 2.2 or less. In the case where Si/C is less than 0.3, it is feared that the hardness of the resin layer is lowered and the life time of the carrier, etc. is reduced. In the case where Si/C is more than 2.2, it is feared that a property to impart charges to the toner of the carrier is easily affected by the change in the temperatures, and accordingly, the resin layer is fragile.

Commercially available silicone resin which can be used in the invention includes, for example: silicone varnish such as TSR115, TSR114, TSR102, TSR103, YR3061, TSR110, TSR116, TSR 117, TSR108, TSR109, TSR180, TSR181, TSR187, TSR144, and TSR165, all of which are trade names and manufactured by TOSHIBA CORPORATION, and KR271, KR272, KR275, KR280, KR282, KR267, KR269, KR211, and KR212, all of which are trade names and manufactured by Shin-Etsu Chemical Co., Ltd.

(Curing Catalyst)

For the crosslinking of the thermosetting silicone resin, it is necessary to perform a heating treatment of the resin at about 150 to 250° C., but in order to make a curing temperature of the resin lower than the melting point of the charge control agent used, a curing catalyst may be added to the resin. Examples of the curing catalyst include octylic acid, tetramethylammonium acetate, tetrabutyl titanate, tetraisopropyl titanate, dibutyltin diacetate, dibutyltin dioctoate, dibutyltin laurate, γ-aminopropyltrimethoxysilane, γ-aminopropyltriethoxysilane, N-(β-aminoethyl)aminopropyltrimethoxysilane, γ-aminopropylmethyldiethoxysilane, N-(β-aminoethyl)aminopropylmethyldimethoxysilane, and the like.

(Method for Forming Resin Layer)

As a method for forming a thermosetting silicone resin layer, a known method can be employed. For example, a primarily coated core particle is prepared by a dipping method in which a raw material of the thermosetting silicone resin layer is dissolved in a solvent, for examples an organic solvent, such as toluene, acetone, and the like, a core particle is dipped in the resulting solution, and then, the organic solvent is evaporated. In the oven, by subjecting this primarily coated core particle to a thermosetting treatment at a temperature lower than the melting point of the charge control agent contained in the thermosetting silicone resin layer, a thermosetting silicone resin Layer can be formed on the surface of the core particle. The temperature upon thermosetting treatment is preferably a temperature that is lower than the melting point of the charge control agent by 5° C. or more and 70° C. or less.

(Coverage)

The coverage of the core particle surface which is a thermosetting silicone resin layer is preferably from 50 to 100%. In the case where the coverage is less than 50%, the resin layer is worn, which leads to too much increase in the exposure amounts of the core particle, and thus, the volume resistivity of the carrier is lowered in some cases. Therefore, adhesion of the carrier or roughness easily occurs. The coverage can be regulated by changing the amount of the resin to be coated. The definition of the coverage by the resin layer of the core particle surface will be described later.

(3) Positively Chargeable Charge Control Agent

As the positively chargeable charge control agent contained in the thermosetting silicone resin layer 102, a known positively chargeable charge control agent can be used, but the thermosetting silicone resin layer 102 preferably comprises one or more of a quaternary ammonium salt represented by the following general formula (1), a quaternary ammonium salt represented by the following general formula (2), and a quaternary ammonium salt represented by the following general formula (3) as the positively chargeable charge control agent. The quaternary ammonium salt substituted with an alkyl group or an aryl group has an excellent dispersibility in a silicone resin and a high charge control effect. By incorporating one or more of the quaternary ammonium salts into the thermosetting silicone resin layer 102, the charge-imparting ability is stabilized even under a high humidity environment, and the toner charging can be started earlier to prevent the decrease in the toner charge amount. In addition, the carrier can be prevented from adhesion on the image bearing member for a long period of time. Further, since the quaternary ammonium salt is colorless, it is difficult to cause contamination with a color toner, and the color image can be prevented from being rendered turbid. Accordingly, an image having a constant image density can be more stably formed without fogging, over a long period of time:

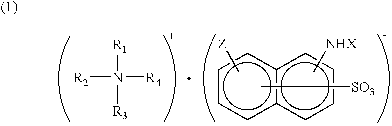

(wherein X represents an alkyl group, a cycloalkyl group, a substituted or unsubstituted phenyl group, or —COR₅ (R₅ is a lower alkyl group), and Z represents a hydrogen atom, a hydroxyl group, or an alkyl group. R₁ and R₃ each independently represent an alkyl group having 1 to 18 carbon atoms, or a benzyl group, R₂ represents an alkyl group having 1 to 4 carbon atoms, and R₄ represents an alkyl group having 5 to 18 carbon atoms, or a benzyl group.), and wherein the ‘lower alkyl group’ refers to an alkyl group having 1 to 4 carbon atoms;

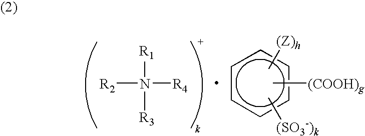

(wherein Z represents a hydrogen atom, a hydroxyl group, a substituted or unsubstituted alkyl group, an alkenyl group, or a carboxylic group, k represents an integer of 1 or 2, g and h each represent an integer of 1 to 3, and a sum of k, g, and h is 6 or less. R₁ to R₄ each independently represent a substituted or unsubstituted alkyl group having 1 to 18 carbon atoms, an alkenyl group having 1 to 18 carbon atoms, a cycloalkyl group, a substituted or unsubstituted phenyl group, or a substituted or unsubstituted benzyl group.); and

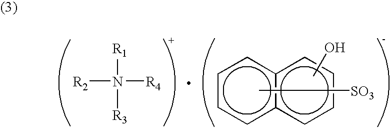

(wherein R₁ represents an alkyl group having 1 to 8 carbon atoms, R₂ and R₃ each independently represent an alkyl group having 1 to 18 carbon atoms, and R₄ represents an alkyl group having 1 to 8 carbon atoms, or a benzyl group.)

Examples of the quaternary ammonium salt represented by the general formula (1) include the following compounds 1 to 3.

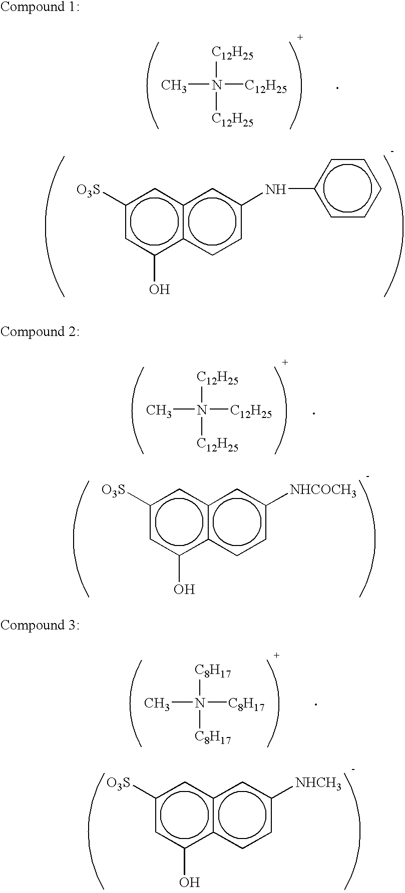

For a method for synthesizing the quaternary ammonium salt represented by the general formula (1), synthesis can be conducted, for example, according to the method as described in JP-A 6-35229 (1994).

Hereinbelow, specific methods for synthesizing Compound 1, Compound 2, and Compound 3 will be described.

(Method for Synthesizing Compound 1)

To a mixed solution of N-phenyl J acid and water is added sodium hydroxide to make its pH 7. 0. To this mixed solution that has been kept at 45° C. is added dropwise a 50% methanol solution of trilaurylmethylammonium chloride for 60 minutes. After completion of dropwise addition, the mixed solution is stirred at 80° C. for 1 hour. After leaving it to be cooled, a solid precipitated in the solution is collected by filtration, and the filtrate collected is washed and dried to obtain Compound 1.

(Method for Synthesizing Compound 2)

Compound 2 is obtained in the same manner as the method for synthesizing Compound 1, except that N-phenyl J acid is used instead of N-acetyl J acid.

(Method for Synthesizing Compound 3)

Compound 3 is obtained in the same manner as the method for synthesizing Compound 1, except that N-phenyl J acid and trilaurylmethylammonium chloride are used instead of N-methyl J acid and trioctylmethylammonium chloride, respectively.

Examples of the quaternary ammonium salt represented by the general formula (2) include the following compounds 4 and 5.

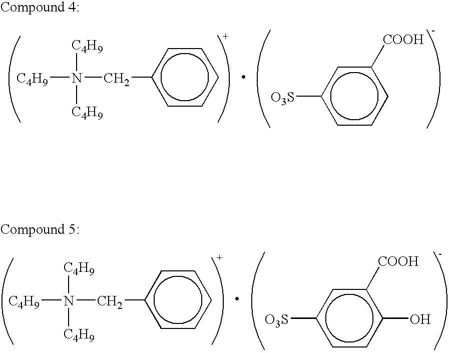

For a method for synthesizing the quaternary ammonium salt represented by the general formula (2), synthesis can be conducted, for example, according to the method as described in Japanese Unexamined Patent Publication JP-A 11-72969 (1999). Next, specific synthesis examples of Compound 4 and Compound 5 will be exemplified.

(Method for Synthesizing Compounds 4 and 5)

1 mole of carboxybenzenemonosulfonic acid derivative is dissolved or dispersed in a suitable solvent such as water, and the like, and at the same time, but separately, 1 mole of quaternary ammonium halide is dissolved or dispersed in a suitable solvent such as water, and the like. And, both the solutions or dispersions are mixed and stirred for a proper time, and the resulting product is filtered or the solvent is removed to obtain Compound 4 or Compound 5.

Examples of the quaternary ammonium salt represented by the general formula (3) include the following compounds to 15.

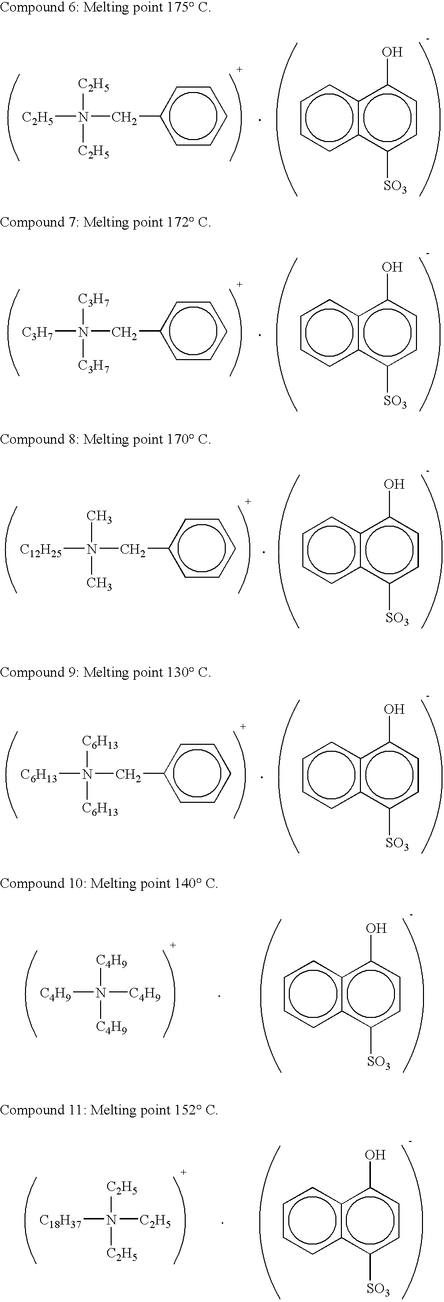

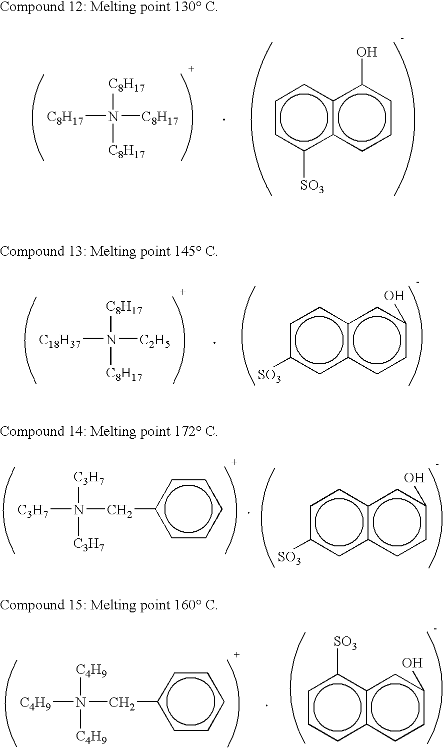

(Method for Synthesizing Quaternary Ammonium Salt Represented by General Formula (3))

1 mole of naphthol sodium sulfonate is dissolved in water, and at the same time, but separately, 1 mole of quaternary ammonium halide is dissolved in water. And, both the solutions are mixed and stirred for a proper time, and the resulting product is filtered to obtain the quaternary ammonium salt represented by the general formula (3).

The charge control agent is preferably present at 5% by weight or more and 20% by weight or less, based on the weight of the thermosetting silicone resin in the thermosetting silicone resin layer 102. By allowing the charge control agent to be present in an amount in this range in the thermosetting silicone resin layer 102, remarkable increase or decrease in the toner charge amount can be efficiently inhibited.

(4) Carrier

The volume average particle size of the carrier of the invention is not particularly limited, but it is preferably from 20 to 100 μm, and more preferably from 30 to 60 μm. In the case where the volume average particle size of the carrier is too small, the carrier easily moves from a developing roller to a photoreceptor drum upon development, and generation of white spots occurs on the resulting image in some cases. In the case where the volume average particle size of the carrier is too large, the dot reproducibility is worsened in some cases, and thus, the image is grainy. The volume average particle size of the carrier means a total particle size of a core particle 101 and a thermosetting silicone resin layer 102 with which the core particle 101 is coated. Specific definition of the volume average particle size will be described later.

The saturation magnetization of the carrier is preferably in the range of 30 to 100 emu/g, and more preferably in the range of 50 to 80 emu/g. Lower the saturation magnetization of the carrier, the softener the magnetic brush in contact with the photoreceptor drum, and thus, an image corresponding to the electrostatic latent image is obtained, but in the case where the saturation magnetization is too low, specifically lower than 30 emu/g, the carrier is adhered onto the photoreceptor drum surface, and a phenomenon of generation of white spots tends to occur. In the case where the saturation magnetization is too high, specifically higher than 100 emu/g, the magnetic brush becomes rigid, which makes it difficult to obtain an image corresponding to the electrostatic latent image. The definition of the saturation magnetization of the carrier will be described later.

The carrier having a resin layer is adhered onto the photoreceptor when the volume resistivity is lowered in some cases. Further, in the case where the volume resistivity of the carrier is enhanced, the increase n the toner charge amount easily occurs. Accordingly, the volume resistivity of the carrier is preferably in the range of 1×10⁸ to 533 10¹² Ω·cm, and more preferably in the range of 1×10⁹ to 5×10¹² Ω·cm. The definition of the volume resistivity of the carrier will be described later.

(5) One Example of First Embodiment

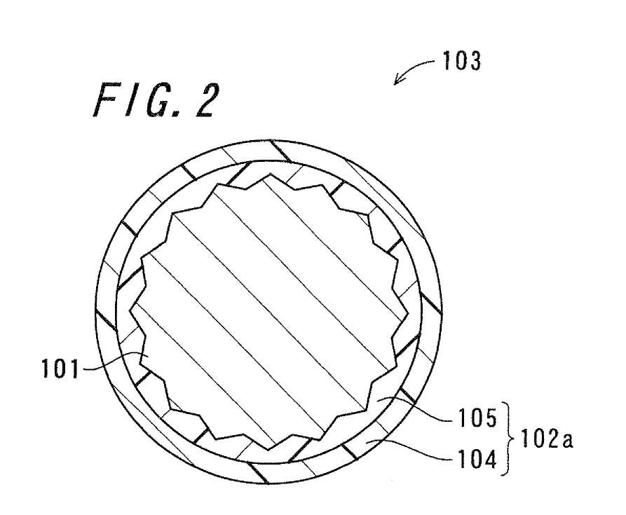

FIG. 2 is a cross-sectional view schematically showing the constitution of the carrier 103 according to one example of the first embodiment of the invention. The carrier 103 of the present embodiment has the same constitution as the carrier 100 shown in FIG. 1, except that it has a thermosetting silicone resin layer 102a on the surface of the core particle 101, and the thermosetting silicone resin layer 101a contains the positively chargeable charge control agent in the inner region 105, and does not contain the charge control agent in the outer region 104. Although the inner region 105 has a higher content of the positively chargeable charge control agent than the outer region 104, and the outer region 104 does not contain any charge control agent, there is no clear interface between the inner region 105 and the outer region 104.

By not incorporating the charge control agent into the outer region 104 of the thermosetting silicone resin layer 102a, the strength of the thermosetting silicone resin layer 101a can be enhanced, as compared with a case where the outer region 104 also contains the charge control agent. By incorporating the positively chargeable charge control agent into the inner region 105 of the thermosetting silicone resin layer 102a, the decrease in the toner charge amount can be inhibited by the positively chargeable charge control agent that is present in the inner region 105 of the thermosetting silicone resin layer 102a, even when the thermosetting silicone resin layer 102a is worn, and the volume resistivity of the carrier 103 is lowered. Accordingly, an image having a constant image density can be even more stably formed without fogging, over a long period of time.

The carrier of the present embodiment can be prepared by first, coating a core particle with a coating solution for primary coating containing a positively chargeable charge control agent, removing the solvent contained in the coating solution for primary coating to prepare a primarily coated core particle, then, coating the primarily coated core particle with a coating solution for secondary coating not containing any charge control agent, and removing the solvent contained in the coating solution for secondary coating to prepare a core particle for secondary coating, and subsequently subjecting the resin layer of the secondarily coated core particle to a thermosetting treatment at a temperature lower than the melting point of the charge control agent.

In the present embodiment, the thickness of the inner region 105 formed from the coating solution for primary coating is preferably 0.5 μm or more and 2 μm or less, and the thickness of the outer region 104 formed from the coating solution for secondary coating is preferably 0.5 μm or more and 1 μm or less.

The thickness of the inner region 105 and the outer region 104 can be simply and easily determined on the basis of an existing determination method for determining using a spherical model from a ratio of the amount of the core particle to be added to the amount of the raw material of thermosetting silicone resin layer.

(6) Another Example of First Embodiment

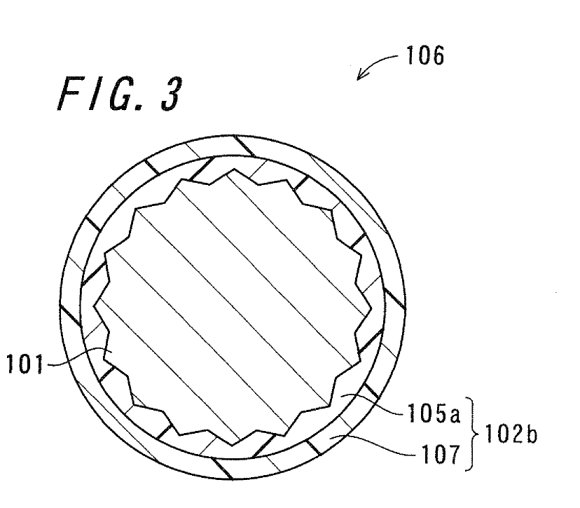

FIG. 3 is a cross-sectional view schematically showing the constitution of the carrier 106 according to another example of the first embodiment of the invention. The carrier 106 of the present embodiment has the same constitution as the carrier 100 shown in FIG. 1, except that the thermosetting silicone resin layer 102b contains a positively chargeable charge control agent in the inner region 105a, and contains a negatively charge control agent in the outer region 107. Although the inner region 105a has a higher content of the positively chargeable charge control agent than the outer region 107, and the outer region 107 has a higher content of the negatively chargeable charge control agent than the inner region 105a, there is no clear interface between the inner region 105a and the outer region 107.

The carrier 106 of the present embodiment can inhibit the decrease in the toner charge amount at the life, as well as can alleviate the increase in the toner charge amount, immediately after a new two-component developer is set in an image forming apparatus, for example, during image forming starting at the initial period up through 2000 sheets. Accordingly, since the unwanted increase in the toner charge amount immediately after a new two-component developer is set in an image forming apparatus, can be prevented, the decrease below a proper range of the image density is inhibited, and an image having a constant image density can be even more stably formed without fogging, over a long period of time. The preferred ranges of the thickness of the outer region 107 and the inner region 105a are the same as the carrier 103, one example of the first embodiment.

(Negatively Chargeable Charge Control Agent)

Examples of the negatively chargeable charge control agent used in the present embodiment include a calixarene compound represented by the following general formula (4).

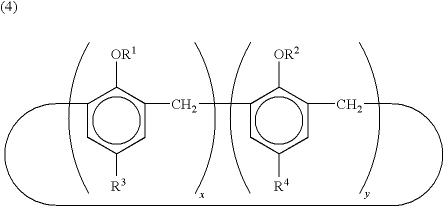

(wherein x+y=n, x and y each represent an integer of 1 or more, n represents an integer of 4 to 8, and x repeating units on one side and y repeating units on the other side can be taken in any order. Further, R₁, R₂, R₃, and R₄ each independently represent a hydrogen atom, an alkyl group having 1 to 12 carbon atoms which may be branched, an aralkyl group having 7 to 12 carbon atoms which may have a substituent, or a phenyl group which may have a substituent.)

In the case where the calixarene compound represented by the general formula (4) is used as a charge control agent, the increase in the charge amount easily occurs, and charging stability is excellent, thereby it being preferable. Further, since it is colorless, it is difficult that the contamination with the color toner occurs, and the color image can be prevented from being turbid.

Examples of the calixarene compound represented by the general formula (4) include the following compound 16.

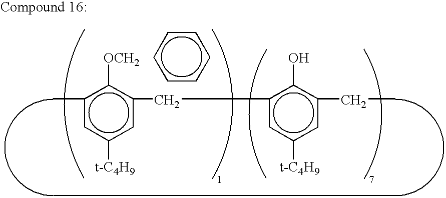

For a method for synthesizing the calixarene compound represented by the general formula (4), synthesis can be conducted, for example, according to the method as described in Japanese Unexamined Patent Publication JP-A 8 -137138 (1996). Next, specific synthesis examples of Compound 16 will be described.

(Method for Synthesizing Compound 16)

Reflux of p-tert-Butylcalix(8)arene and potassium carbonate are performed in methyl isobutyl ketone (MIBK) for 8 hours, and then benzyl bromide is added, followed by performing a reaction under reflux for 30 hours. After the reaction solution is naturally cooled, this is filtered by suction, and the resulting filtrate is dried and solidified under reduced pressure. This is recrystallized using chloroform/n-hexane to obtain Compound 16.

The carrier of the present embodiment can be prepared by first, coating a core particle with a coating solution for coating containing a positively chargeable charge control agent, removing the solvent contained in the coating solution for primary coating to prepare a primarily coated core particle, then, coating the primarily coated core particle with a coating solution for secondary coating containing a negatively chargeable charge control agent, removing the solvent contained in the coating solution for secondary coating to prepare a core particle for secondary coating, and subsequently subjecting the resin layer of the secondarily coated core particle to a thermosetting treatment at a temperature lower than the melting point of the charge control agent. As in the present embodiment, in a case where a plurality of the charge control agents are contained in the resin layer, it is preferable to perform a thermosetting treatment at a temperature lower than the melting point of the charge control agent that has a lowest melting point among others.

In the present embodiment, the ratio of the weight of the positively chargeable charge control agent to the weight of the negatively chargeable charge control agent is preferably in the range of 2:1 to 1:2. The positively chargeable charge control agent is present in the inner region of the thermosetting silicone resin layer and the negatively chargeable charge control agent is present in the outer region, but both the charge control agents are present in the boundary between the place where the positively chargeable charge control agent is present and the place where the negatively chargeable charge control agent is present, and accordingly, the charge control effect is not sufficiently exhibited. Accordingly, in the case where the weight of the positively chargeable charge control agent is too small compared with that of the negatively chargeable charge control agent, the resin layer is worn, and the charge-imparting ability of the positively chargeable charge control agent is not sufficiently exhibited at a life when the volume resistivity of the carrier is lowered, and therefore, the decrease in the charge amount cannot be inhibited, whereby the fogging occurs. In the case where the weight of the positively chargeable charge control agent is too great compared with that of the negatively chargeable charge control agent, the charge control effect of the negatively chargeable charge control agent is not sufficiently exhibited at the initial period of the image forming, and accordingly, the charge amount is unwantedly increased, whereby the image density was lowered. By setting the ratio of the weight of the positively chargeable charge control agent to the weight of the negatively chargeable charge control agent to be in the range of 2:1 to 1:2, the increase in the toner charge amount at the initial period is clearly alleviated, and the decrease in the toner charge amount can be clearly inhibited at a life, and accordingly, an image having a constant image density can be even more stably formed without fogging, over a long period of time.

(Conductive Agent)

In the present embodiment, it is preferable that the thermosetting silicone resin layer further contains a conductive agent in the outer region. By further incorporating a conductive agent into the outer region of the resin layer, the increase in the toner charge amount, immediately after a new two-component developer is set in an image forming apparatus, for example, during image forming starting at the initial period up through 2000 sheets, can be more clearly alleviated. Accordingly, since the unwanted increase in the toner charge amount can be prevented immediately after a new two-component developer is set in an image forming apparatus, the decrease below a proper range of the image density is inhibited, and an image having a constant image density can be even more stably formed without fogging, over a long period of time.

The conductive agent is not particularly limited as long as it can regulate the volume resistivity of the carrier, and examples thereof include conductive agents such as silicon oxide, alumina, carbon black, graphite, zinc oxide, titanium black, iron oxide, titanium oxide, tin oxide, potassium titanate, calcium titanate, aluminum borate, magnesium oxide, barium sulfate, calcium carbonate, and the like. The conductive agents can be used singly, or in combination of two or more kinds thereof.

Among these substances, carbon black is preferred in terms of production stability, cost, and low electric resistance. The kind of carbon black is not particularly limited, but one having a DBP (dibutyl phthalate) oil absorption in the range of 90 ml to 170 ml/100 g is preferred from a viewpoint of the excellent production stability. Moreover, one having a primary particle size of 50 nm or less is particularly preferred due to the excellent dispersibility.

It is preferable that the content of the conductive agent is in a range of from 0.1 to 20 parts by weight based on 100 parts by weight of the resin constituting the resin layer. In the case where the content is less than 0.1 part by weights conductivity cannot be obtained in some cases. On the other hand, in the case where the content is more than 20 parts by weight, the excess conductivity yields the charge to leak in some cases.

2. Two-Component Developer

The two-component developer according to a second embodiment of the invention is composed of a toner and a carrier, wherein the carrier of the invention as described above is used as the carrier. The carrier of the invention has good dispersibility of the charge control agent in the thermosetting silicone resin layer as described above, and there is no denaturation of the charge control agent. By using the carrier of the invention as described above and the toner as the two-component developer, the change in the abilities of the carrier to impart charges to the toner can be inhibited, and the toner can be stably charged with a constant amount of charge. Accordingly, a two-component developer which is capable of stably forming an image having a constant image density without fogging, over a long period of time can be made.

(1) Toner

The toner is not particularly limited, but a known toner can be used. For example, the toners as described below can be used.

The toner is equipped with a colored resin particle (toner particle), and if necessary, an external additive adhered on the surface of the colored resin particle. It is preferable that the external additive is contained in the toner from a viewpoint of preventing the toner for aggregation, and thus of preventing the transfer efficiency from being lowered upon transfer from a photoreceptor drum to a recording medium.

(1)-1. Colored Resin Particle

The colored resin particle comprises a binder resin, a colorant, and if necessary, a release agent, and a charge control agent.

(Binder Resin)

As the binder resin, known various styrenic resins, an acrylic resin, a polyester resin, and the like can be used. Among these, particularly a linear or non-linear polyester resin is preferred. The polyester resin is excellent from a viewpoint that it can satisfy the mechanical strength, the fixing property, and the anti-hot offset property simultaneously. By this, it is difficult for fine powders to be generated, and it is difficult for the toner image to be peeled off from the paper after fixing.

Polyester resin can be obtained by polymerizing monomer compounds composed of divalent or higher-valent polyalcohol and polybasic acid.

The divalent alcohol used for polymerization of polyester resin includes, for example: diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, and 1,6-hexanediol; and bisphenol A alkylene oxide adduct such as bisphenol A, hydrogenated bisphenol A, polyoxyethylenated bisphenol A, and polyoxypropylenated bisphenol A and the like.

The divalent polybasic acid includes, for example, maleic acid, fumaric acid, citraconic acid, itaconic acid, glutaconic acid, phthalic acid, isophthalic acid, terephthalic acid, cyclohexanedicarboxlic acid, succinic acid, adipic acid, sebacic acid, azelaic acid, malonic acid, and anhydrides of these acids, lower alkyl ester, or alkenyl succinic acids or alkyl succinic acids such as n-dodecenyl succinic acid or n-dodecyl succinic acid.

If necessary, at least any one of a trivalent or higher-valent alcohol, or a trivalent or higher-valent polybasic acid may be added to a monomer composition. Examples of the trivalent or higher-valent alcohol include sorbitol, 1,2,3,6-hexanetetrol, 1,4-sorbitan, pentaerythritol, dipentaerythritol, tripentaerythritol, sucrose, 1,2,4-butanetriol, 1,2,5-pentanetriol, glycerol, 2-methylpropanetriol, 2-methyl-1,2,4-butanetriol, trimethylolethane, trimethylolpropane, 1,3,5-trihydroxymethylbenzene, and the like.

The trivalent or higher-valent polybasic acid includes, for example, 1,2,4-benzenetricarboxylic acid, 1,2,5-benzenetricarboxylic acid, 1,2,4-cyclohexanetricarboxylic acid, 2,5,7-naphthalenetricarboxylic acid, 1,2,4-naphthalenetricarboxylic acid, 1,2,5-hexanetricarboxylic acid, 1,3-dicarboxy-2-methyl-2-methylenecarboxypropane, tetra(methylenecarboxyl)methane, 1,2,7,8-octanetetracarboxylic acid, and anhydrides thereof.

(Colorant)

For the colorant, known pigments and dyes generally used for toner can be used.

Specifically, a colorant for black toner includes carbon black and magnetite.

A colorant for yellow toner includes: acetoacetic arylamide monoazo yellow pigments such as C.I. pigment yellow 1, C.I. pigment yellow 3, C.I. pigment yellow 74, C.I. pigment yellow 97, and C.I. pigment yellow 98; acetoacetic arylamide disazo yellow pigments such as C.I. pigment yellow 12, C.I. pigment yellow 13, C.I. pigment yellow 14, and C.I. pigment yellow 17; condensed monoazo yellow pigments such as C.I. pigment yellow 93 and C.I. pigment yellow 155; other yellow pigments such as C.I. pigment yellow 180, C.I. pigment yellow 150, and C.I. pigment yellow 185; and yellow dye such as C.I. solvent yellow 19, C.I. solvent yellow 77, C.I. solvent yellow 79, and C.I. disperse yellow 164.

A colorant for magenta toner includes, for example: red or bright red pigment such as C.I. pigment red 48, C.I. pigment red 49:1, C.I. pigment red 53:1, C.I. pigment red 57, C.I. pigment red 57:1, C.I. pigment red 81, C.I. pigment red 122, C.I. pigment red 5, C.I. pigment red 146, C.I. pigment red 184, C.I. pigment red 238, and C.I. pigment violet 19; and red dye such as C.I. solvent red 49, C.I. solvent red 52, C.I. solvent red 58, and C.I. solvent red 8.

A colorant for cyan toner includes, for example: blue dye and pigments of copper phthalocyanine and derivatives thereof such as C.I. pigment blue 15:3 and C.I. pigment blue 15:4; and green pigments such as C.I. pigment green 7 and C.I. pigment green 36 (phthalocyanine green).

The content of the colorant is preferably about 1 to 15 parts by weight, and more preferably in the range of 2 to 10 parts by weight, based on 100 parts by weight of the binder resin.

(Charge Control Agent)

As the charge control agent that can be used in the toner, a known charge control agent can be used.

Examples of the negatively chargeable charge control agent which is a charge control agent imparting negative charges to the toner include a chromium azo complex dye, an iron azo complex dye, a cobalt azo complex dye, a complex or salt compound of a salicylic acid and a derivative thereof with chromium, zinc, aluminum, or boric acid, a complex or salt compound of naphtholic acid and a derivative thereof with chromium, zinc, aluminum, or boric acid, a complex or salt compound of benzylic acid and a derivative thereof with chromium, zinc, aluminum, or boric acid, a long-chain alkylcarboxylate, a long-chain alkylsulfonate, and the like.

Examples of the charge control agent which is a charge control agent imparting positive charges include a nigrosine dye and a derivative thereof, a triphenylmethane derivative, and derivatives such as a quaternary ammonium salt, a quaternary phosphonium salt, a quaternary pyridinium salt, a guanidine salt, an amidine salt, and the like.

The content of the charge control agent is preferably in the range of 0.1 part by weight to 20 parts by weight, and more preferably in the range of 0.5 part by weight to 10 parts by weight, based on 100 parts by weight of the binder resin.

(Release Agent)

Examples of the release agent contained in the colored resin particle include a synthetic wax such as polypropylene, polyethylene, and the like, a petroleum-based wax such as a paraffin wax and a derivative thereof, a microcrystalline wax and a derivative thereof, and the like, and a modified wax thereof, and a vegetable wax such as a carnauba wax, a rice wax, a candelilla wax, and the like. By incorporating these release agents into the colored resin particle, the releasing property of the toner with respect to a fixing roller or a fixing belt can be enhanced, and thus, high-temperature offset upon fixing and low-temperature offset can be prevented. The amount of the release agent to be added is not particularly limited, but it is preferably 1 part by weight or more and 5 parts by weight or less, based on 100 parts by weight of the binder resin.

The coloring resin particles can be manufactured by a known method such as a kneading/pulverizing method or a polymerization method. Specifically, in the case of applying the kneading/pulverizing method, the binder resin, the colorant, the charge control agent, the release agent, and other additives are mixed with each other in a mixer such as HENSCHELMIXER, SUPERMIXER, MECHANOMILL, and a Q-type mixer. A raw material mixture thus obtained is melt-kneaded at a temperature around 100° C. or more and 180° C. or less by a kneading machine selected from a twin-screw kneader, a single-screw kneader, etc. A kneaded material thus obtained is then cooled down to be solidified, and a solidified material thus obtained is then pulverized by an air pulverizer such as a jet mill, followed by particle size adjustment such as classification according to need. The coloring resin particles can be thus manufactured.

The volume average particle size of the colored resin particles is preferably in the range of 4 to 7 μm. In the case where the volume average particle size is in this range, an image excellent in the dot reproducibility, and having a high image quality with little fogging or toner scattering can be obtained. The definition of the volume average particle size will be described later.

The coloring resin particles preferably have BET specific surface area of 1.5 m²/g or more and 1.9 m²/g or less. Coloring resin particles with BET specific surface area exceeding 1.9 m²/g will have more irregular surfaces whose concave parts catch an external additive, and thus there is a fear that the external additive cannot be evenly attached to the surfaces of the coloring resin particles. In this case, the coloring resin particles will fail to be provided with sufficient skid effect of enhancing flowability of the external additive and spacer effect of preventing charges from leaking, thus being more liable to cause fogging and scattering of toner. In the case where coloring resin particles with BET specific surface area less than 1.5 m²/g tend to have too smooth surfaces, and therefore there is a fear that cleaning failure occurs, thereby causing the fogging. The definition of the BET specific surface area will be described later.

(1)-2. External Additive

As the external additive which is externally added to the colored resin particle, an inorganic particle composed of silica, titanium oxide, alumina, and the like and having a number average particle size of 7 nm or more and 100 nm or less can be used. Further, by subjecting the inorganic particle to a surface treatment by means of a silane coupling agent, a titanium coupling agent, or a silicone oil, hydrophobicity may be imparted. The inorganic particle on which that hydrophobicity is imparted is reduced in the lowering of electric resistance and the charge amount under a high humidity, whereby it is preferred. Particularly, a silica particle having a trimethylsilyl group introduced to the surface, using hexanemethyldisilazane (which may be hereinafter referred to as HMDS) as a silane coupling agent, is excellent in hydrophobicity or insulating property. A toner to which the silica particle is externally added can provide excellent charging property even under an environment of a high humidity. The definition of the number average particle size will be described later.

Specific examples of the external additive include Aerosil 50 (number average particle size: about 30 nm), Aerosil 90 (number average particle size: about 30 nm), Aerosil 130(number average particle size: about 16 nm), Aerosil 200 (number average particle size: about 12 nm), Aerosil 300 (number average particle size: about 7 nm), Aerosil 380 (number average particle size: about 7 nm) (all of these being silica), each of which is manufactured by Nippon Aerosil Co., Ltd., Aluminum Oxide C (alumina; number average particle size: about 13 nm) manufactured by Degussa AG (Germany), Titanium Oxide P-25 (titanium oxide; number average particle size: about 21 nm) manufactured by Degussa AG (Germany), MOX170 (a silica•alumina mixture; number average particle size: about 15 nm), and TTO-51 (titanium oxide, number average particle size: about 20 nm), TTO-55(titanium oxide, number average particle size: about 40 nm), and the like, each of which is Ishihara Sangyo Kaisha, Ltd.

The external additives are externally added to the coloring resin particles by mixing the external additives with the coloring resin particles by using an airflow mixer such as a Henschel mixer.

The amount of the external additive to be added is preferably from 0.2 to 3% by weight. In the case where the amount is less than 0.2% by weight, sufficient flowability cannot be given to a toner in some cases. To the contrary, in the case where the amount is more than 3% by weight, the fixing property of the toner is lowered in some cases.

(2) Two-Component Developer

In a case of obtaining a toner containing an external additive, the colored resin particle and the external additive are mixed. The mixing ratio of the carrier to the toner is, for example, 3 to 15 parts by weight of the toner to 100 parts by weight of the carrier. Examples of the method for mixing the carrier and the toner include a method for mixing using a mixer such as a Nauta mixer.

By using the carrier of the invention having good dispersibility of the charge control agent in the thermosetting silicone resin layer and having no denaturation of the charge control agent as described above and the toner as a two-component developer, the change in the abilities of the carrier to impart charges to the toner can be inhibited, and the toner can be stably charged with a constant amount of charge. Accordingly, a two-component developer which is capable of stably forming an image having a constant image density without fogging, over a long period of time can be made.

3. Image Forming Apparatus

The image forming apparatus of a third embodiment of the invention is not limited to ones specified with regard to other constructions, as long as it uses, as a developer, the two-component developer according to the invention as described above, and any known one having the construction of an electrophotographic image forming apparatus using the two-component developer can be employed.

The image forming apparatus of the invention can be, for example, an electrophotographic copier, a printer, a facsimile, or a multifunctional peripheral having functions of the devices mentioned above.

Hereinbelow, the image forming apparatus of the invention is described specifically with reference to the figures.

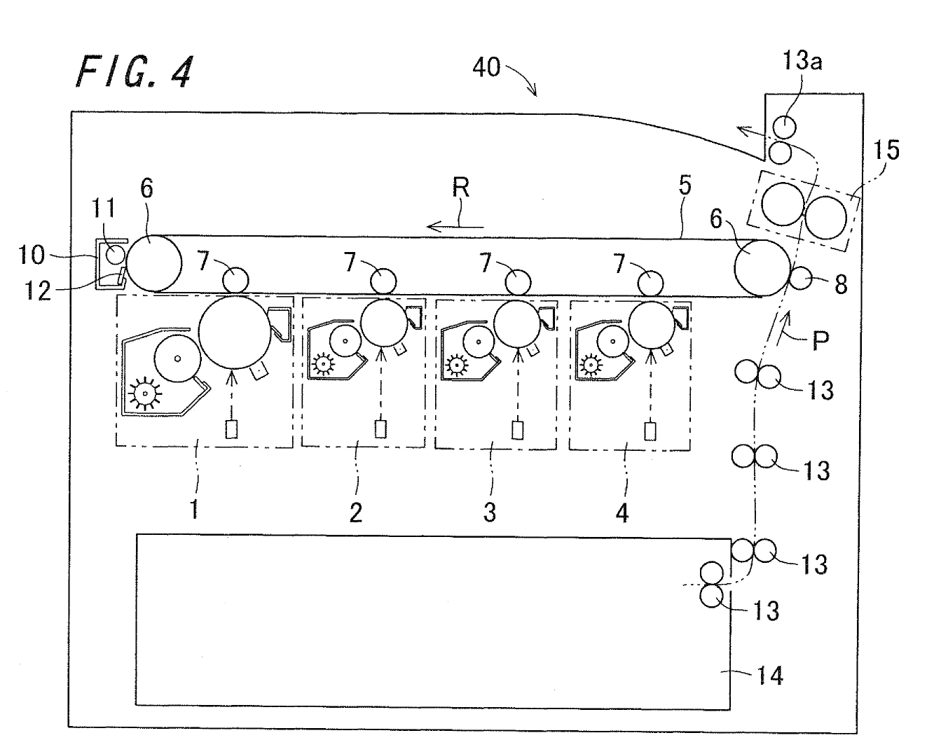

FIG. 4 is a diagram schematically showing the construction of the image forming apparatus 40 of the third embodiment of the invention. The image forming apparatus of the invention is not limited to the construction of the image forming apparatus 40 as shown in FIG. 4. As shown in FIG. 4, the image forming apparatus 40 is a color image forming apparatus in a tandem mode, provided with four image forming units 1 to 4.

The image forming apparatus 40 comprises a first image forming unit 1 for forming a black toner image, a second image forming unit 2 for forming a cyan toner image, a third toner forming unit 3 for forming a magenta toner image, and a fourth image forming unit 4 for forming a yellow toner image as the four image forming units 1 to 4.

With reference to FIG. 4, an intermediate transfer belt 5 that is an endless belt is provided in the upper portion of the four image forming units 1 to 4. The intermediate transfer belt 5 is supported around two supporting rolls 6, and is configured to rotate in the direction as indicated with an arrow R. A second transfer roller 8 is provided opposite to one supporting roll 6 with the intermediate transfer belt 5 interposed therebetween. Thereafter, the rotation direction of the intermediate transfer belt 5 is defined as upstream or downstream by setting a second transfer position in which the second transfer roller 8 is arranged as a base point. As the materials of the intermediate transfer belt 5, it is possible to use a material containing an electron-conductive material in a thermosetting silicone resin such as polyimide, polyamide, or the like in a proper amount.

For the four image forming units 1 to 4, the first image forming unit 1 for forming a toner image corresponding to a black image information, the second image forming unit 2 for forming a toner image corresponding to a cyan color image information, the third image forming unit 3 for forming a toner image corresponding to a magenta color image information, and the fourth image forming unit 4 for forming a toner image corresponding to a yellow image information are arranged in this order, in the direction from the upstream side to the downstream side in the rotation direction R of the intermediate transfer belt 5.

In the inner region of the intermediate transfer belt 5, a first transfer roller 7 for transferring the monochromatic toner image formed on each of the image forming units 1 to 4 onto the intermediate transfer belt 5 is provided in opposite to each of the image forming units 1 to 4 with the intermediate transfer belt 5 interposed therebetween. The monochromatic toner images formed on the respective image forming units 1 to 4 are transferred and overlaid on top of one another on the intermediate transfer belt 5 to form one color toner image.

At the downstream side in the rotation direction R of the intermediate transfer belt 5 relative to the fourth image forming unit 4 for forming a toner image corresponding to a yellow image information, the second transfer roller 8 for transferring the color image formed on the intermediate transfer belt 5 onto a recording medium is provided.

At the downstream side in the rotation direction R of the intermediate transfer belt 5 relative to the second transfer roller 8, a belt cleaning unit 10 for cleaning the surface of the intermediate transfer belt 5 is provided. The belt cleaning unit 10 has a belt cleaning brush 11 arranged to be in contact with the intermediate transfer belt 5, and a belt cleaning blade 12. The belt cleaning blade 12 is arranged at the downstream side in the rotation direction R of the intermediate transfer belt relative to the belt cleaning brush 11. After the second transfer, the toner remaining on the intermediate transfer belt 5 without being transferred onto the recording medium, is removed from the belt cleaning unit 10.

With reference to FIG. 4, a tray 14 for accommodating recording mediums is provided in the lower portion of the four image forming units 1 to 4. The recording medium in the tray 14 is conveyed to the second transfer position where the second transfer roller 8 is opposite to the intermediate transfer belt 5, by means of a plurality of paper feeding rollers 13. The arrow P represents a conveying direction of the recording medium.

At the downstream side in the conveying direction P of the recording medium relative to the second transfer roller 8, a fixing unit 15 for fixing the color toner image transferred onto the recording medium on the recording medium is provided. Also, at the downstream side in the conveying direction P of the recording medium relative to the fixing unit 15, a paper-discharging roller 13a for discharging the recording medium having the color toner image fixed thereon from the image forming apparatus 40 is provided.

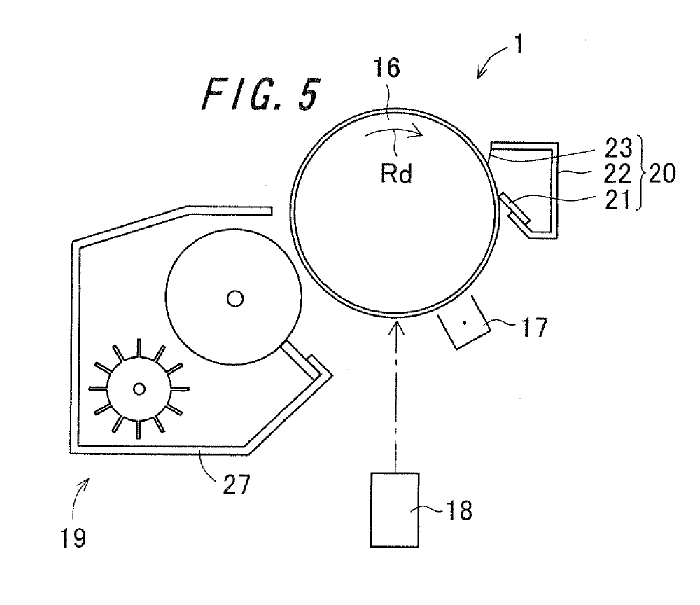

FIG. 5 is a diagram showing the first image forming unit 1 as shown in FIG. 4. The constructions of the second image forming unit 2, the third image forming unit 3, and the fourth image forming unit 4 are substantially the same constructions as each other. Accordingly, as to the first image forming unit 1, the second image forming unit 2, the third image forming unit 3, and the fourth image forming unit 4, detailed descriptions of their constructions will be omitted.

The first image forming unit 1 comprises a cylindrical photoreceptor drum 16 serving as an image bearing member, a charging device 17 for charging the photoreceptor drum 16, an exposure device 18 for writing an electrostatic latent image on the photoreceptor drum 16, a developing device 19 for visualizing the electrostatic latent image on the photoreceptor drum 16, and a photoreceptor drum cleaner 20 for removing a residue comprising the toner remaining on the photoreceptor drum 16 after the first transfer. The charging device 17, the exposure device 18, the developing device 19 and the photoreceptor drum cleaner 20 are provided around the photoreceptor drum 16. The charging device 17 and the exposure device 18 function as a latent image forming section.

The charging device 17 is a non-contact type charging device in the present embodiment, and is implemented, for example, by a scorotron charging device, and charges the photoreceptor drum 16 by performing corona discharging on the photoreceptor drum 16 at a predetermined potential. The charging device 17 may be implemented by a corotron charging device. Moreover, the charging device 17 is not limited to the non-contact type charging device, but may be implemented by a contact type charging device, for example, a charging roller or a charging brush.

The exposure device 18 is composed of, for example, a laser exposure device, performs exposure by laser irradiation in the response to an image signal, and changes the surface potential of the photoreceptor drum 16 charged by the charging device 17, thereby forming an electrostatic latent image according to image information. As the exposure device, an LED array unit, and the like can be used.

The developing device 19 accommodates a developer containing the toner of the invention inside the developing tank 27, and develops the electrostatic latent image of the surface of the photoreceptor drum 16 by the toner contained in the developer to form a toner image. Examples of the developer include a two-component developer composed of a toner and a carrier, and a one-component developer containing only a toner without a carrier. In the image forming apparatus 40 of the present embodiment, the developing device 19 accommodates a two-component developer inside the developing tank 27, and has a construction corresponding to the two-component developer.

The photoreceptor drum cleaner 20 is equipped with a cleaning blade 21, a cleaning housing 22, and a seal 23.

The cleaning blade 21 is arranged in pressure-contact with the photoreceptor drum 16 in a counter direction relative to the rotation direction Rd thereof, and scrapes off the residue on the surface of the photoreceptor drum 16. The cleaner housing 22 accommodates the scraped residue, and the cleaning blade 21 is attached to the cleaner housing 22. The seal 23 is sealed inside the cleaner housing 22, and at the upstream side in the rotation direction Rd of the photoreceptor drum 16 relative to the cleaning blade 21, one end is fixed on the cleaner housing 22, and at the same time, the other end is arranged in contact with the photoreceptor drum 16.

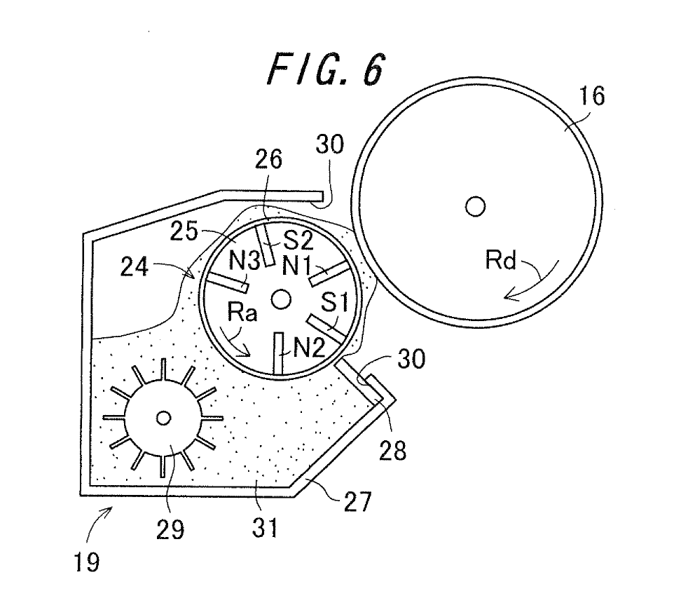

FIG. 6 is a diagram showing the construction of the periphery of the developing device 19 in the first image forming unit 1 as shown in FIG. 5. The developing device 19 includes a developing tank 27 for accommodating the two-component developer (which may be hereinafter simply a ‘developer’ in some cases) 31, and in the developing tank 27, an opening portion 30 opened facing the outer circumferential surface of the photoreceptor drum 16 is formed at a position facing the outer circumferential surface of the photoreceptor drum 16.

Inside the developing tank 27, provided is a developing roller 24 facing the outer circumferential surface of the photoreceptor drum 16 through the opening of the opening portion 30. The developing roller 24 has a cylindrical shape, supplies a toner in the developer to the photoreceptor drum 16 by bearing the developer 31 on its outer circumferential surface and conveying it, and develops the electrostatic latent image on the photoreceptor drum 16. The developing roller 24 is arranged at an interval from the outer circumferential surface of the photoreceptor drum 16.

The developing roller 24 has a cylindrical shape, and includes a multi-pole magnetized member 25 having plural poles magnetized, and a nonmagnetic sleeve 26 that is rotatably fitted to the exterior of the multi-pole magnetized member 25. The multi-pole magnetized member 25 has its both edge parts in the axial direction that is non-rotatably supported on both walls of the developing tank 27.

In the multi-pole magnetized member 25, a plurality of magnetic poles are separately arranged at a plurality of positions in the circumference direction thereof. The magnetic pole of the multi-pole magnetized member 25 is formed, for example, by radially arranging a bar magnet having a rectangular shape of a cross section shape at a plurality of positions in the circumference direction of multi-pole magnetized member 25. In the present embodiment, five magnetic poles, specifically three N poles N1, N2, and N3, and two S poles S1 and S2 are arranged in the multi-pole magnetized member 25.

The magnetic pole N1 is arranged at a position facing the photoreceptor drum 16. By taking a rotation axis line of the sleeve 26 as a rotation center, the magnetic pole S1 is arranged at the upstream side in the rotation direction Ra of the sleeve 26 from the magnetic pole N1, for example, arranged at a position displaced at 59°, the magnetic pole N2 is arranged at the upstream side in the rotation direction Ra of the sleeve 26 from the magnetic pole N1, for example, arranged at a position displaced at 117°, the magnetic pole N3 is arranged at the upstream side in the rotation direction Ra of the sleeve 26 from the magnetic pole N1, for example, arranged at a position displaced at 224°, and the magnetic pole S2 is arranged at the upstream side in the rotation direction Ra of the sleeve 26 from the magnetic pole N1, for example, arranged at a position displaced at 282°.

When the density of the magnetic flux at the N pole is taken as positive (plus (+)), and the density of the magnetic flux at the S pole is taken as negative (minus (−)), the peak value of the magnetic flux densities of the magnetic pole N1 is, for example, 110 mT, the peak value of the magnetic flux densities of the magnetic pole S1 is, for example, −78 mT, the peak value of the magnetic flux densities of the magnetic pole N2 is, for example, 56 mT, the peak value of the magnetic flux densities of the magnetic pole N3 is, for example, 42 mT, and the peak value of the magnetic flux densities of the magnetic pole S2 is, for example, −80 mT.

At a position opposite to the region at the downstream in the rotation direction Ra of the sleeve 26 relative to the pumping pole N2, which is near the opening portion 30 of the developing tank 27, and also, at the upstream in the rotation direction Ra of the sleeve 26 relative to a portion facing the photoreceptor drum 16 of the developing roller 24, a regulating member 28 which regulates the thickness of the developer layer supported on the outer circumferential surface of the developing roller 24, and thus, regulates the amount of the developer to be conveyed to the electrostatic latent image is provided. The regulating member 28 is arranged at a predetermined spacing from the outer circumferential surface of the developing roller 24.

Inside of the developing tank 27, at a position facing developing roller 24, an agitating member 29, which agitates the developer inside the developing tank 27, and at the same time, supplies it to the developing roller 24, is provided to be rotatable.

As described above, the developing device 19 develops the electrostatic latent image formed on the image bearing member using the two-component developer of the invention, thereby forming a visible image. Since the two-component developer of the invention has a stable toner charge amount from an initial period up through a life, the developing device 19 which is capable of stably forming a good toner image without fogging, over a long period of time, by using the two-component developer of the invention can be implemented. Further, as described above, an image forming apparatus 40 is attained by incorporating the developing device 19 of the invention capable of forming a toner image without fogging and toner scattering. By forming an image with the image forming apparatus 40 as described above, an image having a constant image density can be stably formed without fogging.

### EXAMPLES

The definitions of the terms, the ‘volume average particle size’, ‘saturation magnetization’, ‘volume resistivity’, ‘number average molecular weight’, ‘coverage’, ‘BET specific surface area’, and ‘number average particle size’, as used in the embodiments of the invention, will be described below.

(Volume Average Particle Size of Carrier and Core Particles)

In the embodiment of the invention, volume average particle sizes of carrier and core particles were measured on the condition of 3.0 bar dispersive pressure by using a dry-type dispersing device: RODOS (manufactured by Sympatec, Inc.) in a laser diffraction particle size analyzer: HELOS (manufactured by Sympatec, Inc.).

(Volume Average Particle Size of Coloring Resin Particles)

In the embodiment of the invention, volume average particle size of coloring resin particles was measured by use of Coulter Multisizer II (manufactured by Beckman Coulter, Inc.) with an aperture of 100 μm.

Specifically, as the measurement device, Coulter Counter TA-II type or Coulter Multisizer II (manufactured by Beckman Coulter, Inc.) is used. As the electrolyte solution, an about 1% aqueous NaCl solution using primary sodium chloride is employed. As the about 1% aqueous NaCl solution, for example, ISOTON R-II (manufactured by Coulter Scientific Japan Co., Ltd.) can be used.

For the measurement method, to 100 to 150 ml of an aqueous solution of the electrolyte solution was added 0.1 to 5 ml of a surfactant, preferably alkylbenzene sulfonate, as a dispersant, and further added 2 to 20 mg of a colored resin particle as a measurement sample. The electrolyte solution in which the measurement sample is suspended is subjected to a dispersion treatment using an ultrasonic disperser for about 1 to 3 minutes, a 100 μm aperture was used as an aperture by the measurement device to measure the volume and the numbers of the colored resin article, thereby determining the volume particle size distribution and the number particle size distribution of the colored resin particle. The volume average particle size of the colored resin particles was determined from the volume particle size distribution of the colored resin particle.

(Saturation Magnetization of Carrier)

In the embodiment of the invention, the saturation magnetization of the carrier refers to a value as measured by VSMP-1 (manufactured by Toei Industry Co., Ltd.).

(Volume Resistivity of Core Particle and Carrier)

In the embodiment of the invention, the volume resistivity of the core particle and the carrier means a value as measured by the following procedure. Firstly, a 6.5 mm gap between two sheets of the copper plate electrodes each having 30 mm width and 10 mm height was filled with 0.2 g of the core particle under an environment condition of a temperature of 20° C. and a humidity of 65%. Next, the particle formed a bridge with magnetic lines of two magnets (100 mT) which are arranged in the outer region of the respective copper plate electrodes so that an N pole and an S pole are opposite to each other. In such a state, the value as measured when 15 seconds had passed after 500 V of a voltage had been applied was taken as a volume resistivity of the core particle. The volume resistivity of the carrier was measured in the same manner.

(Coverage of Thermosetting Silicone Resin Layer)

In the embodiment of the invention, the coverage of the thermosetting silicone resin layer on the core particle surface means a value as determined by the following method. Without deposition of a conductive agent such as gold, and the like on the carrier surface, it was observed using a scanning electron microscope (SEM) with an electron beam of an acceleration voltage of 2.0 eV. At this time, in the carrier, the thermosetting silicone resin layer was observed to be white by charge-up. A ratio of the white region area to the total area of the carrier was determined. This determination was performed on 100 carriers, and an average value of the resulting values was taken as a coverage of the thermosetting silicone resin layer on the core particle surface.

(BET Specific Surface Area of Colored Resin Particle)

In the embodiment of the invention, a BET specific surface area of the colored resin particle was measured in a BET specific surface area analyzer: Gemini 2360 (manufactured by Shimadzu Corporation) through a three-point analysis process.

(Number Average Particle Size of External Additives)

In the embodiment of the invention, the number average particle size of the external additives means an average value of the particle sizes as measured by taking a photograph of fine particles using a scanning electron microscope (SEM), and measuring the particle sizes of any 100 fine particles from the obtained image.

Hereinbelow, Examples of the invention will be described, but the invention is not limited to Examples.

<Synthesis of Charge Control Agent>

[Synthesis 1]

To a mixed solution of 20.74 g of N-phenyl J acid and 300 ml of water was added sodium hydroxide to make its pH be 7.0. To this mixed solution that had been kept at 45° C. was added dropwise a 50% methanol solution of 55.85 g of trilaurylmethylammonium chloride for 60 minutes. After completion of dropwise addition, the mixed solution was stirred at 80° C. for 1 hour. After leaving it to be cooled, a solid precipitated in the solution was collected by filtration, and the filtrate collected was washed with water and dried to obtain 63.87 g of a pale gray powder of Compound 1 (melting point: 177° C.) (yield: 93.8%).

[Synthesis 2]

35.84 g of a white powder of Compound 2 (melting point: 167° C.) was obtained in the same manner as the method for synthesizing Compound 1, except that N-phenyl J acid was used instead of 37.50 g of N-acetyl J acid (yield: 56.2%).

[Synthesis 3]

45.91 g of a pale brown powder of Compound 3 (melting point: 175° C.) was obtained in the same manner as the method for synthesizing Compound 1, except that N-phenyl J acid and trilaurylmethylammonium chloride were used instead of 20.74 g of N-methyl J acid and 39.67 g of trioctylmethyl ammonium chloride, respectively (yield: 84.0%).

[Synthesis 4]

One mole of sodium m-carboxybenzene sulfonate was dissolved in water, and at the same time, but separately, 1 mole of tri-n-butylbenzeneammonium chloride was dissolved in water. And, both the solutions or the dispersions are mixed and stirred for a proper time, and the resulting product is filtered to obtain Compound 4 (melting point 143° C.)

[Synthesis 5]

Compound 5 (melting point: 185° C.) was obtained in the same manner as the method as in Synthesis Example 4, except that 3-carboxy-4-hydroxybenzenesodium sulfonate was used instead of m-carboxybenzenesodium sulfonate.

[Synthesis 6]

12.96 g (0.01 mol) of p-tert-butylcalix(8)arene and 4.14 g (0.03 mol) of potassium carbonate were refluxed in 100 ml of methyl isobutyl ketone (MIBK) for 8 hours, and then 5.1 g (0.03 mol) of benzyl bromide was added thereto, followed by performing a reaction under reflux for 30 hours. After the reaction solution was naturally cooled, this was filtered by suction, and the resulting filtrate was dried and solidified under reduced pressure. This was recrystallized using chloroform/n-hexane to obtain 7 g of a white powder of Compound 16 (melting point: 205° C.).

The structures of Compounds 1 to 5, and 16 are as described above.

<Preparation of Carrier>

### Example 1

(Preparation of Core Particle)

As the raw materials of a ferrite, a slurry containing 50 mol % of iron oxide (manufactured by KDK Corporation), 35 mol % of manganese oxide (manufactured by KDK Corporation), 14.5 mol % of magnesium oxide (manufactured by KDK Corporation), and 0.5 mol % of strontium oxide (manufactured by KDK Corporation) and having water as a medium was pulverized with a ball mill for 4 hours. This slurry was dried in a spray drier, and the particle of the resulting spherical particle was tentatively fired in a rotary kiln at 930° C. for 2 hours. This tentatively fired powder was dispersed in water, and finely pulverized to an average particle size of 2 μm or less in a wet pulverizer (using a steel ball as a pulverizing medium). 2% by weight of PVA was added to this slurry, granulated by a spray dryer, dried, and subjected to main firing in an electric furnace at a temperature of 1100° C. and an oxygen concentration of 0 volume % for 4 hours. Then, performing crushing and gradation were performed to obtain a core particle composed of a ferrite component having a volume average particle size of 44 μm and a volume resistivity of 1×10⁹ Ω·cm.

(Primary Coating)

A coating solution for primary coating containing a positively chargeable charge control agent was prepared by dissolving 100 parts by weight of a dimethyl silicone resin (manufactured by Toshiba Silicones), 5 parts by weight of Compound 1 (melting point: 177° C.) as a positively chargeable charge control agent, and 5 parts by weight of octylic acid as a curing agent in 890 parts by weight of a mixed solution of toluene and methanol (toluene:methanol=10:1). In a coating device for a dipping method (product name: Versatile Mixer NDMV type, manufactured by DALTON CORPORATION), the core particle was coated with a thermosetting silicone resin containing a positively chargeable charge control agent by dipping 100 parts by weight of the core particle in 30 parts by weight of the coating solution for primary coating. Then, by completely removing toluene by evaporation, a primarily coated core particle having a coverage of the thermosetting silicone resin layer of 100% was prepared.

(Secondary Coating)

A coating solution for secondary coating not containing a charge control agent was prepared by dissolving 100 parts by weight of a dimethyl silicone resin (manufactured by Toshiba Silicones), and 5 parts by weight of octylic acid as a curing agent in 895 parts by weight of toluene. In a coating device for a dipping method (product name: Versatile Mixer NDMV type, manufactured by DALTON CORPORATION), the primarily coated core particle was coated with a thermosetting silicone resin not comprising a charge control agent by dipping 103 parts by weight of the primarily coated core particle in 30 parts by weight of the coating solution for secondary coating. After completely removing the solvent by evaporation, the primarily coated core particle was subjected to a thermosetting treatment by heating it in an oven at 150° C. for 60 minutes, thereby preparing a carrier of Example 1 having a coverage of the thermosetting silicone resin of 100%. The carrier of Example 1 had a volume average particle size of 45 μm, a volume resistivity of 2×10¹² Ω·cm, and a saturation magnetization of 65 emu/g.

### Examples 2 to 11 and Comparative Examples 1 to 6

The carriers of Examples 2 to 11 and Comparative Examples 1 to 6 were prepared in the same manner as in Example 1, except that at least one of the types of the charge control agent, the amount of the charge control agent to be added, a temperature upon thermosetting treatment, or a time upon thermosetting treatment was changed into one as shown in Table 1.

TABLE 1

| | Primary coating | | | Condition for | | | |
|---|---|---|---|---|---|---|---|
| | Charge control agent | | | thermosetting treatment | | Carrier | |
| | | Melting | | Thermosetting | Thermosetting | Volume | Saturation |
| | | point | Addition amount | temperature | time | average particle | magnetization |
| | Type | (° C.) | (parts by weight) | (° C.) | (minutes) | size (μm) | (emu/g) |
| Example 1 | Compound 1 | 177 | 5 | 150 | 60 | 45 | 65 |
| Example 2 | Compound 2 | 167 | 5 | 140 | 60 | 45 | 65 |
| Example 3 | Compound 3 | 175 | 5 | 145 | 60 | 45 | 65 |
| Example 4 | Compound 4 | 143 | 5 | 110 | 60 | 45 | 65 |
| Example 5 | Compound 5 | 185 | 5 | 155 | 60 | 45 | 65 |
| Example 6 | Compound 1 | 177 | 5 | 170 | 30 | 45 | 65 |
| Example 7 | Compound 1 | 177 | 5 | 110 | 120 | 45 | 65 |
| Example 8 | Compound 3 | 175 | 5 | 165 | 30 | 45 | 65 |
| Example 9 | Compound 3 | 175 | 5 | 105 | 120 | 45 | 65 |
| Example 10 | Compound 5 | 185 | 5 | 175 | 30 | 45 | 65 |
| Example 11 | Compound 5 | 185 | 5 | 115 | 120 | 45 | 65 |
| Comparative | — | — | 0 | 150 | 60 | 45 | 65 |
| Example 1 | | | | | | | |
| Comparative | Compound 1 | 177 | 5 | 185 | 60 | 45 | 65 |
| Example 2 | | | | | | | |
| Comparative | Compound 2 | 167 | 5 | 175 | 60 | 45 | 65 |
| Example 3 | | | | | | | |
| Comparative | Compound 3 | 175 | 5 | 180 | 60 | 45 | 65 |
| Example 4 | | | | | | | |
| Comparative | Compound 4 | 143 | 5 | 150 | 60 | 45 | 65 |
| Example 5 | | | | | | | |
| Comparative | Compound 5 | 185 | 5 | 190 | 60 | 45 | 65 |
| Example 6 | | | | | | | |

### Example 12

(Primary Coating)

A coating solution for primary coating containing a positively chargeable charge control agent was prepared by dissolving 100 parts by weight of a dimethyl silicone resin (manufactured by Toshiba Silicones), 5 parts by weight of Compound 1 (melting point: 177.3° C.) as a positively chargeable charge control agent, and 5 parts by weight of octylic acid as a curing agent in 890 parts by weight of a mixed solution of toluene and methanol (toluene:methanol=10:1). In a coating device for a dipping method (product name: Versatile Mixer NDMV type, manufactured by DALTON CORPORATION), the core particle was coated with a thermosetting silicone resin containing a positively chargeable charge control agent by dipping 100 parts by weight of the core particle obtained in Example 1 (preparation of a core particle) in 30 parts by weight of the coating solution for primary coating. Then, by completely removing the solvent from the coated core particle by evaporation, a thermosetting treatment was performed by heating it in an oven at 150° C. for 60 minutes, thereby preparing a primarily coated core particle.

(Secondary Coating)

A coating solution for secondary coating containing a negatively chargeable charge control agent was prepared by dissolving 5 parts by weight of Compound 6 (melting point: 205° C.) as a charge control agent, 100 parts by weight of a dimethyl silicone resin (manufactured by Toshiba Silicones), and 5 parts by weight of octylic acid as a curing agent in 895 parts by weight of toluene. In a coating device for a dipping method (product name: Versatile Mixer NDMV type, manufactured by DALTON CORPORATION), the primarily coated core particle was coated by dipping 103 parts by weight of the primarily coated core particle in 30 parts by weight of the coating solution for secondary coating. In the same manner as for the preparation of the primarily coated core particle in Example 12, by completely removing the solvent from the coated primarily coated core particle by evaporation, a heat treatment (thermosetting) was performed by heating it in an oven at 150° C. for 60 minutes, thereby preparing a carrier of Example 12.

### Examples 13 to 22

The carriers of Examples 13 to 22 were prepared in the same manner as in Example 12, except that at least one of the types of the charge control agent, a temperature upon thermosetting treatment, or a time upon thermosetting treatment was changed into one as shown in Table 2.

TABLE 2

| | Primary coating | | | Secondary coating | | | | | | |
|---|---|---|---|---|---|---|---|---|---|---|
| | Charge control agent | | | Charge control agent | | | Condition for | | Carrier | |
| | | | Addition | | | Addition | thermosetting treatment | | Volume | |
| | | Melting | amount | | Melting | amount | Thermosetting | | average | Saturation |
| | | point | (parts by | | point | (parts by | temperature | Thermosetting | particle size | magnetization |
| | Type | (° C.) | weight) | Type | (° C.) | weight) | (° C.) | time (minutes) | (μm) | (emu/g) |
| Example 12 | Compound 1 | 177 | 5 | Compound 6 | 205 | 5 | 150 | 60 | 46 | 65 |
| Example 13 | Compound 2 | 167 | 5 | Compound 6 | 205 | 5 | 140 | 60 | 46 | 65 |
| Example 14 | Compound 3 | 175 | 5 | Compound 6 | 205 | 5 | 145 | 60 | 46 | 65 |
| Example 15 | Compound 4 | 143 | 5 | Compound 6 | 205 | 5 | 110 | 60 | 46 | 65 |
| Example 16 | Compound 5 | 185 | 5 | Compound 6 | 205 | 5 | 155 | 60 | 46 | 65 |
| Example 17 | Compound 1 | 177 | 5 | Compound 6 | 205 | 5 | 170 | 30 | 46 | 65 |
| Example 18 | Compound 1 | 177 | 5 | Compound 6 | 205 | 5 | 110 | 120 | 46 | 65 |
| Example 19 | Compound 3 | 175 | 5 | Compound 6 | 205 | 5 | 165 | 30 | 46 | 65 |
| Example 20 | Compound 3 | 175 | 5 | Compound 6 | 205 | 5 | 105 | 120 | 46 | 65 |
| Example 21 | Compound 5 | 185 | 5 | Compound 6 | 205 | 5 | 175 | 30 | 46 | 65 |
| Example 22 | Compound 5 | 185 | 5 | Compound 6 | 205 | 5 | 115 | 120 | 46 | 65 |

### Examples 23 to 26

The carriers of Examples 23 to 26 were prepared in the same manner as in Example 12, except that the amount of the coating solution for primary coating to be added upon coating the core particle obtained in (Preparation of Core Particle) of Example 1, and the amount of the coating solution for secondary coating to be added upon coating the primary coating particle were changed into ones as shown in Table 3. By changing the amounts of the coating solution for primary coating and the coating solution for secondary coating to be each added, the ratio of the weight of the positively chargeable charge control agent to the weight of the negatively chargeable charge control agent, which are each contained in the thermosetting silicone resin layer, can be changed.

TABLE 3

| | Primary coating | | | | | | | | | |
|---|---|---|---|---|---|---|---|---|---|---|
| | | | Coating | | | | | | | |
| | | | solution | Secondary coating | | | | | | |
| | | | for | | | Coating | | | | |
| | | | Primary | | | solution | | | Carrier | |
| | Charge | | coating | Charge | | for Secondary | Condition for | | Volume | |
| | control agent | | Addition | control agent | | coating | thermosetting treatment | | average | |
| | | Melting | amount | | Melting | Addition | Thermosetting | | particle | Saturation |
| | | point | (parts by | | point | amount (parts | temperature | Thermosetting | size | magnetization |
| | Type | (° C.) | weight) | Type | (° C.) | by weight) | (° C.) | time (minutes) | (μm) | (emu/g) |
| Example 23 | Compound 1 | 177 | 50 | Compound 6 | 205 | 10 | 150 | 60 | 46 | 65 |
| Example 24 | Compound 1 | 177 | 40 | Compound 6 | 205 | 20 | 150 | 60 | 46 | 65 |
| Example 25 | Compound 1 | 177 | 20 | Compound 6 | 205 | 40 | 150 | 60 | 46 | 65 |
| Example 26 | Compound 1 | 177 | 10 | Compound 6 | 205 | 50 | 150 | 60 | 46 | 65 |

<Preparation of Toner>

The carriers and toners used in Examples 1 to 26 and Comparative Examples 1 to 6 were prepared in the following methods.

The materials for the toner are described below.

| | |
|---|---|
| Binder resin (bisphenol A propylene oxide, a | 100 parts by weight |
| polyester resin obtained by polycondensation of | |
| terephthalic acid or anhydrous trimellitic acid as | |
| monomers: glass transition temperature 60° C., | |
| softening temperature 115° C.: manufactured by | |
| Fujikura Kasei Co. Ltd.) | |
| Colorant (C.I. Pigment/Blue 15:3) | 5 parts by weight |
| Charge control agent (boron compound, product | 2 parts by weight |
| name: LR-147, manufactured by Japan | |
| Carlit Co., Ltd.) | |
| Release agent (microcrystalline wax, product | 3 parts by weight |
| name: HNP-9, manufactured by Nippon Seiro | |
| Co., Ltd.) | |

The above-described toner materials were mixed at a Henschel mixer for 10 minutes, and then melt-kneaded using a kneading/dispersing processor (product name: KNEADEX MOS 140-800, manufactured by Mitsui Mining Co., Ltd.) to obtain a kneaded material in which the toner materials other than the binder resin had been dispersed in the binder resin. The kneaded material was coarsely pulverized with a cutting mill, and then, finely pulverized by means of a jet type pulverizer (product name: IDS-2 type, manufactured by Nippon Pneumatic MFG. Co., Ltd.). The finely pulverized material was classified by using a pneumatic classifier (product name: MP-250 type, manufactured by Nippon Pneumatic MFG. Co., Ltd.) to obtain a colored resin particle having a volume average particle size of 6.5±0.1 μm and a BET specific surface area of 1.8±0.1 m²/g.

To 100 parts by weight of the obtained colored resin particle was added 1 part by weight of a silica particle that had been subjected to a surface treatment with hexamethyldisilazane having a number average particle size of 12 nm (product name: R8200, manufactured by Evonic Degussa Industries), followed by stirring using an air flow mixer (a Henschel mixer, manufactured by Mitsui Mining Co., Ltd.) having an end speed of a stirring blade set as 15 m/sec. for 2 minutes to prepare a negatively chargeable toner T1.

<Two-Component Developer>

By mixing the carrier and the toner T1 of each of Examples 1 to 26 and Comparative Examples 1 to 6, the two component developers of Examples 1 to 26 and Comparative Examples 1 to 6 were prepared. The two-component developer was prepared by introducing 6 parts by weight of the toner and 94 parts by weight of the carrier of each of Examples 1 to 26 and Comparative Examples 1 to 6 into a Nauta mixer (product name: VL-0, manufactured by Hosokawa Micron Corporation), and mixing under stirring for 20 minutes.

<Evaluation of Image>

For the two-component developers comprising the carriers of Examples 1 to 26 and Comparative Examples 1 to 6, a continuous print test was carried out using the image forming apparatus (an aging tester) as shown in FIG. 4. For the continuous print test, only the image forming unit 1 was used among the four image forming units of the image forming apparatus. The conditions for development of the image forming apparatus were as follows: the circumferential speed of the photoreceptor was set at 400 mm/sec; the circumferential speed of the developing roller was set at 560 mm/sec; the gap between the photoreceptor and the developing roller was set at 0.42 mm; the gap between the developing roller and the regulating blade was set at 0.5 mm; and the surface potential and the developing bias of the photoreceptor were set so that the amount of the toner adhered to paper was 0.5 mg/cm² with the least amount of toner adhered to a non-image area in a solid image (100% density). For the test paper, an A4-sized electrophotographic paper: Multi-receiver manufactured by Sharp Document System Corporation was used.

A continuous print test of 70,000 (which will be hereinafter described as ‘70 k’) sheets was carried out using a text image was carried cut in which the coverage of the printed image recorded on the test paper was 6%, and measurement of the toner charge amount, and measurement of the image density and the fogging density the 2000 (which will be hereinafter described as ‘2 k’) sheets and 70 k sheets were made. The measurement method and evaluation method for each of these values will be described later.

(Charge Amount of Toner)

The charge amount of the toner was measured by using a small-sized suction type charge measurement system: Model 210HS-2A manufactured by Trek Japan K.K.

(Image Density)

The image density was measured in a manner that a 3 cm-square solid image (100% density) was printed, and the image density of the printed part was measured by a reflection densitometer (RD918 manufactured by Macbeth AC). The image density was evaluated based on the following criteria: Good: the image density was 1.50 or more; Available: the image density was 1.3 or more and less than 1.50 with the fibers of the paper covered by the toner, showing the state of the unevenness of the fibers; and Poor: the image density was less than 1.3 with the fibers of the paper were seen.

(Fogging)

As to the fogging density, density of non-image area (0% density) was calculated as the following steps. Whiteness of the test paper not yet printed was measured by a whiteness checker: Z-Σ90 Color Measuring System (trade name) manufactured by Nippon Denshoku industries Co., Ltd. Next, whiteness of non-image area in the test paper printed was measured by the above whiteness checker. And a difference was determined between the whiteness of the test paper not yet printed and the whiteness of the non-image area in the test paper printed. The difference was defined as fogging density. The fogging density was evaluated based on the following criteria: Good: the fogging density was less than 0.5 and the fogging was hardly visible to the naked eye; Available: the fogging density was 0.5 or more and less than 0.8 and the fogging was slightly visible to the naked eyes; and Poor: the fogging density was 0.8 or more and the fogging was clearly visible to the naked eye.

<Results>

The results of the continuous print test are shown in Table 4 and Table 5.

TABLE 4

| | After 2k-sheet printing | | | | | After 70k-sheet printing | | | | |
|---|---|---|---|---|---|---|---|---|---|---|
| | Charge | Image density | | Fogging | | Charged | Image density | | Fogging | |
| | amount | Image | | Fogging | | amount | Image | | Fogging | |
| | (μc/g) | density | Evaluation | density | Evaluation | (μc/g) | density | Evaluation | density | Evaluation |
| Example 1 | 25.5 | 1.32 | Available | 0.08 | Good | 21.7 | 1.67 | Good | 0.41 | Good |
| Example 2 | 24.2 | 1.30 | Available | 0.17 | Good | 22.0 | 1.72 | Good | 0.38 | Good |
| Example 3 | 24.9 | 1.31 | Available | 0.13 | Good | 22.1 | 1.72 | Good | 0.36 | Good |
| Example 4 | 24.0 | 1.31 | Available | 0.15 | Good | 22.7 | 1.63 | Good | 0.32 | Good |
| Example 5 | 25.6 | 1.34 | Available | 0.10 | Good | 22.5 | 1.64 | Good | 0.32 | Good |
| Example 6 | 25.4 | 1.32 | Available | 0.07 | Good | 22.0 | 1.75 | Good | 0.35 | Good |
| Example 7 | 24.9 | 1.30 | Available | 0.16 | Good | 21.5 | 1.76 | Good | 0.43 | Good |
| Example 8 | 24.5 | 1.31 | Available | 0.15 | Good | 22.3 | 1.67 | Good | 0.34 | Good |
| Example 9 | 24.8 | 1.33 | Available | 0.17 | Good | 22.4 | 1.64 | Good | 0.35 | Good |
| Example 10 | 24.3 | 1.31 | Available | 0.14 | Good | 23.1 | 1.59 | Good | 0.31 | Good |
| Example 11 | 24.1 | 1.32 | Available | 0.17 | Good | 22.9 | 1.61 | Good | 0.33 | Good |
| Example 12 | 22.4 | 1.65 | Good | 0.23 | Good | 22.3 | 1.69 | Good | 0.33 | Good |
| Example 13 | 22.7 | 1.72 | Good | 0.24 | Good | 22.0 | 1.70 | Good | 0.37 | Good |
| Example 14 | 22.6 | 1.63 | Good | 0.22 | Good | 22.1 | 1.67 | Good | 0.34 | Good |
| Example 15 | 23.1 | 1.60 | Good | 0.21 | Good | 22.8 | 1.69 | Good | 0.33 | Good |
| Example 16 | 23.6 | 1.58 | Good | 0.19 | Good | 23.4 | 1.74 | Good | 0.31 | Good |
| Example 17 | 23.3 | 1.59 | Good | 0.20 | Good | 22.9 | 1.65 | Good | 0.34 | Good |
| Example 18 | 23.7 | 1.51 | Good | 0.21 | Good | 23.8 | 1.68 | Good | 0.29 | Good |
| Example 19 | 23.9 | 1.52 | Good | 0.19 | Good | 23.5 | 1.67 | Good | 0.30 | Good |
| Example 20 | 23.2 | 1.59 | Good | 0.22 | Good | 24.3 | 1.74 | Good | 0.27 | Good |
| Example 21 | 23.4 | 1.54 | Good | 0.23 | Good | 24.2 | 1.59 | Good | 0.28 | Good |
| Example 22 | 23.6 | 1.59 | Good | 0.20 | Good | 24.3 | 1.61 | Good | 0.29 | Good |
| Example 23 | 24.9 | 1.34 | Available | 0.11 | Good | 22.7 | 1.64 | Good | 0.23 | Good |
| Example 24 | 22.7 | 1.65 | Good | 0.23 | Good | 22.5 | 1.72 | Good | 0.33 | Good |
| Example 25 | 21.5 | 1.78 | Good | 0.23 | Good | 20.5 | 1.57 | Good | 0.45 | Good |
| Example 26 | 21.3 | 1.78 | Good | 0.23 | Good | 13.8 | 1.55 | Good | 0.78 | Available |

TABLE 5

| | After 2k-sheet printing | | | | | After 70k-sheet printing | | | | |
|---|---|---|---|---|---|---|---|---|---|---|
| | Charge | Image density | | Fogging | | Charged | Image density | | Fogging | |
| | amount | Image | | Fogging | | amount | Image | | Fogging | |
| | (μc/g) | density | Evaluation | density | Evaluation | (μc/g) | density | Evaluation | density | Evaluation |
| Comparative | 24.1 | 1.45 | Available | 0.18 | Good | 16.6 | 1.95 | Good | 1.06 | Poor |
| Example 1 | | | | | | | | | | |
| Comparative | 24.5 | 1.39 | Available | 0.17 | Good | 17.5 | 1.89 | Good | 0.86 | Poor |
| Example 2 | | | | | | | | | | |
| Comparative | 24.7 | 1.37 | Available | 0.17 | Good | 17.2 | 1.85 | Good | 0.88 | Poor |
| Example 3 | | | | | | | | | | |
| Comparative | 24.8 | 1.36 | Available | 0.15 | Good | 17.3 | 1.87 | Good | 0.84 | Poor |
| Example 4 | | | | | | | | | | |
| Comparative | 24.4 | 1.37 | Available | 0.16 | Good | 17.0 | 1.92 | Good | 0.85 | Poor |
| Example 5 | | | | | | | | | | |
| Comparative | 24.5 | 1.35 | Available | 0.18 | Good | 17.9 | 1.88 | Good | 0.82 | Poor |
| Example 6 | | | | | | | | | | |

As shown in Table 4, in Examples 1 to 26 in which the thermosetting silicone resin layer was formed by performing a thermosetting treatment at temperature lower than the melting point of the charge control agent, the toner charge amounts were stable, the image density was high, and there was no generation of fogging, even after 70 k-sheet printing.

As shown in Table 5, in Comparative Examples 2 to 6 in which the thermosetting silicone resin layer was formed by performing a thermosetting treatment at temperature higher than the melting point of the charge control agent, the decrease in the toner charge amount was observed after 70 k-sheet printing, accompanied by generation of fogging.

As shown in Table 4, in Examples 12 to 22 in which the thermosetting silicone resin layer contained a positively chargeable charge control agent in the inner region and contained a negatively chargeable charge control agent in the outer region, and was formed by performing a thermosetting treatment at temperature lower than the melting point of the charge control agent contained in the resin layer, the toner charge amounts were stable, the image density was high, and there was no generation of fogging, over a long period of time after 2 k-sheet printing and 70 k-sheet printing. In particular, after 2 k-sheet printing, a higher image density was obtained, as compared with ones in Examples 1 to 11 in which the thermosetting silicone resin layer contained a positively chargeable charge control agent in the inner region and did not contain a negatively chargeable charge control agent in the outer region, and was formed by performing a thermosetting treatment at temperature lower than the melting point of the charge control agent contained in the resin layer.

In Examples 24 and 25 in which the ratio of the weight of the positively chargeable charge control agent to the weight of the negatively chargeable charge control agent was in the range of 2:1 to 1:2, the toner charge amounts were stable, the image density was high, and there was no generation of fogging, over a long period of time, after 2 k-sheet printing and 70 k-sheet printing. In Example 23 in which the ratio of the weight of the positively chargeable charge control agent to the weight of the negatively chargeable charge control agent was 5:1, the increase in the toner charge amount was seen after 2 k-sheet printing, and the image density was slightly lowered. Further, in Example 26 in which the ratio of the weight of the positively chargeable charge control agent to the weight of the negatively chargeable charge control agent was 1:5, the decrease in the toner charge amount was observed after 70 k-sheet printing, accompanied by generation of slight fogging after 70 k-sheet printing.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A carrier comprising a core particle and a thermosetting silicone resin layer formed of a thermosetting silicone resin on a surface of the core article,
the thermosetting silicone resin layer being formed by subjecting the thermosetting silicone resin to a thermosetting treatment at a temperature lower than a melting point of a charge control agent contained in the thermosetting silicone resin layer, the thermosetting silicone resin layer including an inner region which contains a positively chargeable charge control agent and an outer region which does not contain any positively chargeable charge control agent.

2. The carrier of claim 1, wherein the thermosetting silicone resin layer contains, as a positively chargeable charge control agent, one or more of a quaternary ammonium salt represented by the following general formula (1), a quaternary ammonium salt represented by the following general formula (2), and a quaternary ammonium salt represented by the following general formula (3): 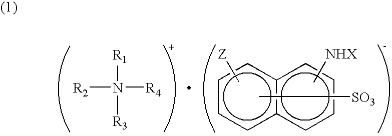
(wherein X represents an alkyl group, a cycloalkyl group, a substituted or unsubstituted phenyl group, or —COR₅ (R₅ is a lower alkyl group), and Z represents a hydrogen atom, a hydroxyl group, or an alkyl group. R₁ and R₃ each independently represent an alkyl group having 1 to 18 carbon atoms, or a benzyl group, R₂ represents an alkyl group having 1 to 4 carbon atoms, and R₄ represents an alkyl group having 5 to 18 carbon atoms, or a benzyl group.); 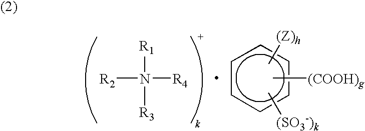
(wherein Z represents a hydrogen atom, a hydroxyl group, a substituted or unsubstituted alkyl group, an alkenyl group, or a carboxylic group, k represents an integer of 1 or 2, g and h each represent an integer of 1 to 3, and a sum of k, g, and h is 6 or less. R₁ to R₄ each independently represent a substituted or unsubstituted alkyl group having 1 to 18 carbon atoms, an alkenyl group having 1 to 18 carbon atoms, a cycloalkyl group, a substituted or unsubstituted phenyl group, or a substituted or unsubstituted benzyl group.); and 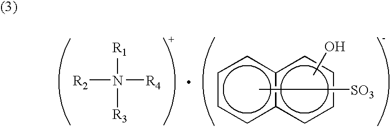
(wherein R₁ represents an alkyl group having 1 to 8 carbon atoms, R₂ and R₃ each independently represent an alkyl group having 1 to 18 carbon atoms, and R₄ represents an alkyl group having 1 to 8 carbon atoms, or a benzyl group.)

3. The carrier of claim 1, wherein the thermosetting silicone resin layer contains the positively chargeable charge control agent in the inner region and contains a negatively chargeable charge control agent in the outer region.

4. The carrier of claim 3, wherein a ratio of a weight of the positively chargeable charge control agent to a weight of the negatively chargeable charge control agent is in a range of 2:1 to 1:2.

5. The carrier of claim 3, wherein the thermosetting silicone resin layer further contains a conductive agent in the outer region.

6. The carrier of claim 1, wherein the thermosetting silicone resin is a dimethyl silicone resin.

7. The carrier of claim 1, wherein the core particle contains a ferrite component.

8. A two-component developer comprising a toner and the carrier of claim 1.

9. A developing device which develops an electrostatic latent image formed on an image bearing member by using the two-component developer of claim 8 to form a visible image.

10. An image forming apparatus comprising:
an image bearing member on which an electrostatic latent image is formed;
a latent image forming section which forms the electrostatic latent image on the image bearing member; and
the developing device of claim 9.
